(19) United States
(12) Patent Application Publication
(10) Pub. No.: US 2025/0324968 A1
(43) Pub. Date: Oct. 23, 2025

(54) PHTHALIMIDE FUNGICIDE COMPOSITION

(71) Applicant: Adama Makhteshim Ltd., Beer Sheva (IL)

(72) Inventors: Diana Poliak, Beer Sheva (IL); Yadagani Venkateswararao, Hyderabad, Telangana (IN); Ivan Gorlovetsky, Beer Sheva (IL); Shachaf Dotan, Ness Ziona (IL); Anna Praiz, Beer Sheva (IL); Viacheslav Firer Slava, Beer Sheva (IL)

(73) Assignee: Adama Makhteshim Ltd., Beer Sheva (IL)

(21) Appl. No.: 18/864,378

(22) PCT Filed: May 11, 2023
(86) PCT No.: PCT/IB2023/054901

§ 371 Date: Nov. 8, 2024

Related U.S. Application Data
(60) Provisional application No. 63/340,807, filed on May 11, 2022.

(30) Foreign Application Priority Data
Jun. 8, 2022 (IN) 202211032874

(51) Int. Cl. A01N 31/02; A01N 25/04; A01N 41/04; A01N 43/48; A01P 3/00

(52) U.S. Cl. CPC A01N 31/02; A01N 25/04; A01N 41/04; A01N 43/48; A01P 3/00

(57) ABSTRACT

The present invention relates to methods for improving the performance, or enhancing the biological activity, of a phthalimide fungicide composition by combining the phthalimide-enhancing adjuvants of the invention with the composition. The invention further provides a combination comprising phthalimide fungicide and phthalimide-enhancing adjuvant for use in the methods. The invention thus also provides methods for producing compositions comprising the combinations and methods of using the combinations and/or the compositions comprising them.

Throughout this application various publications are referenced. The disclosures of these documents in their entireties are hereby incorporated by reference into this application in order to more fully describe the state of the art to which this invention pertains.

### TECHNICAL FIELD

The present invention relates to methods for improving the performance, or enhancing the biological activity, of a phthalimide fungicide composition by combining the phthalimide-enhancing adjuvants of the invention with the composition. The invention further provides a combination comprising phthalimide fungicide and phthalimide-enhancing adjuvant for use in the method. The invention thus also provides methods for producing compositions comprising the combination and methods of using the combinations and/or the compositions comprising them.

### BACKGROUND

Agricultural pest control includes chemical control based on substances that are toxic to the pests involved, while causing little or no toxic effects to the agricultural plants.

Chemical control agents can be incredibly beneficial and have contributed to increased food production over the past century. However, when a pesticide is applied it may be carried into the environment by leaching into the soil or drifting through the air. In addition, human exposure to pesticide may sometimes cause adverse health effects ranging from simple irritation of the skin and/or eyes to more severe effects such as affecting the nervous system. An on-going challenge in agriculture is to control pests while increasing the efficacy of the pesticide and/or reducing the amounts of chemical control agents typically, pesticides that are applied.

Phthalimide fungicides are non-systemic contact fungicides which are used for controlling a variety of pathogens in different crops. Different compositions are known comprising phthalimide fungicides especially, folpet (N-(trichloromethylthio)phthalimide) and/or captan (N-(trichloromethylthio)cyclohex-4-ene-1,2-dicarboximide).

Most phthalimides such as folpet and captan are hardly soluble in water. Examples of current commercial formulations are Folpan 80WDG, Merpan 47.5 SC, Merpan 80WDG, Farm-Ag Folpet 500 SC, AGN-CAPTAN 500 SC, with high concentrations of folpet and captan as active ingredient in the range of 30-70%. Other phthalimide fungicides useful in this invention include ditalimfos (o, o-diethyl phthalimido phosphonothioate), captafol (N-[(1,1,2,2-tetrachloroethyl)thio]-3a,4,7,7a-tetrahydrophthalimide) and thiochlorfenphim (N-{[(4-chlorophenyl)thio]methyl}phthalimide).

The efficacy of pesticides in solid particulate form is limited and there is an on-going need to improve the performance of the pesticidal compositions containing them.

There is also an on-going need to improve the compositions comprising phthalimide fungicide, in particular to provide improved control of pathogens.

A general problem affecting the application of active agrochemical ingredients is that only a fraction of the active ingredients displays the desired activity. The greater portion is often lost unutilized, in that the active ingredient does not reach the leaves or roots of the plant on deployment, of a spray application but, seeps away unutilized in the soil, is not well assimilated at the target plant, is washed away by rain, and/or is simply not properly or efficiently absorbed by the plant. But another problem may also be that the active agrochemical ingredient does not penetrate in a sufficient amount, if at all, into non-plant harmful organisms that are to be controlled and hence does not display its full efficacy. For better absorption of active agrochemical ingredients into plants, an important role is played, for example, by substances that promote the penetration of active agrochemical ingredients into the plants. Typical representatives are esterified vegetable oils which increase the penetration rate through the leaf surface, or mineral oils which increase the contact area. However, agents with these mechanisms of action are often in need of improvement for reasons such as inadequate plant compatibility, problems with use or stability in formulations or application liquids, inadequate action, excessive application rates or costs. Furthermore, fungicides which are applied as solid particles suspended in aqueous media (water) have an especially pronounced need for enhancing adjuvants that are compatible with aqueous systems.

### DESCRIPTION OF FIGURES

FIG. 1. Efficacy of a tank-mix of commercial Captan 480SC and Fluxapyroxad 300SC compositions.

FIG. 2. Result of 1st Test Set—4 rep per treatment 200 L/ha.

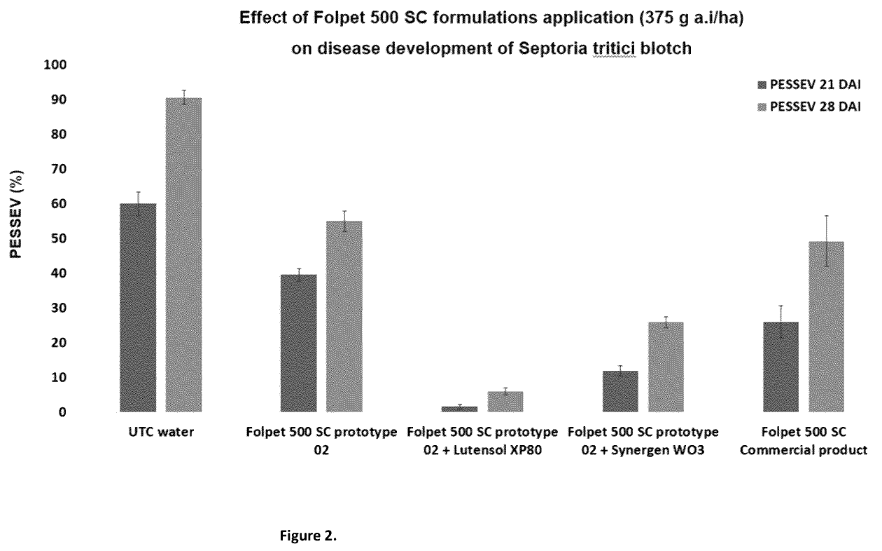

FIG. 3. Result of 2nd Test Set—4 rep per treatment 200 L/ha.

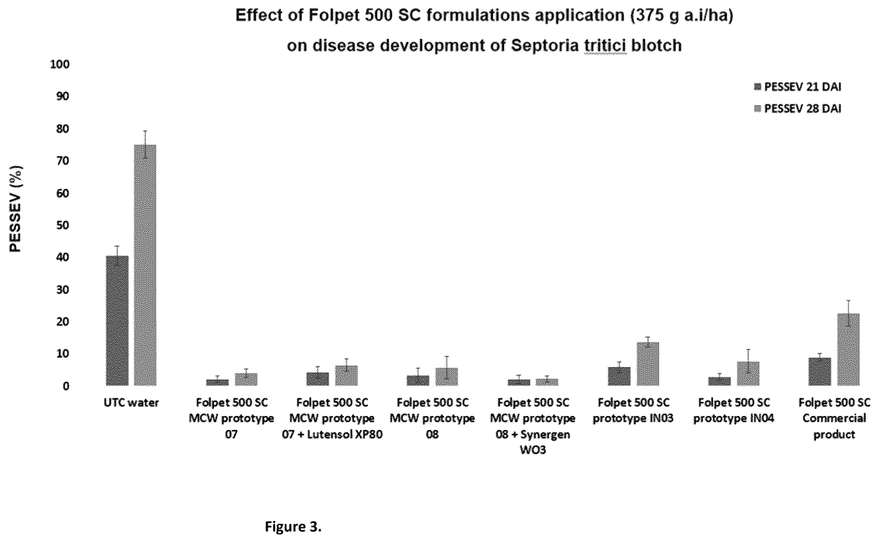

### SUMMARY OF THE INVENTION

The present invention relates to the use of specific additives or auxiliaries as phthalimide-enhancing or preferably synergistic adjuvants for agrotechnical applications, in particular in the field of crop protection with phthalimide fungicides. The present invention thus also provides combinations comprising phthalimide fungicide and certain phthalimide-enhancing additives or auxiliaries as adjuvant. Methods of improving or enhancing phthalimide compositions and improved or enhanced compositions comprising the combinations of phthalimide fungicide and certain additives or auxiliaries as adjuvant are also described.

In some embodiments, the compositions that are improved and/or enhanced by addition of the phthalimide-enhancing adjuvants of the invention, comprise one or more polyelectrolyte and in some embodiments the improved compositions comprise a complex of more than one polyelectrolyte, in addition to the inventive phthalimide-enhancing adjuvants herein disclosed. In some embodiments at least one of the polyelectrolytes is selected from the group of polycation and polyanion.

Thus, in at least one embodiment the invention provides a method of improving the performance or enhancing the biological activity of a pre-existing phthalimide fungicide composition by combining the additives or auxiliaries of the invention often referred to herein as phthalimide-enhancing adjuvants, with the pre-existing composition thus enhancing the performance of those compositions.

In some embodiments, the compositions whose performance and efficacy are enabled to be enhanced by combination with the inventive adjuvants, are compositions containing combinations of phthalimide fungicide and one or more polyelectrolyte, and in noted cases combinations of phthalimide fungicide with complexes of at least two polyelectrolytes.

In some embodiments, the compositions whose performance and efficacy are enabled to be enhanced by combination with the inventive adjuvants, are compositions containing complexes of phthalimide fungicide with one or more polyelectrolytes.

The phthalimide fungicides for use in the inventive combinations include captafol, captan, ditalimfos, folpet, thiochlorfenphim, and any combination thereof, which are herein often exemplified by folpet without any intention of being limited thereto.

In some embodiments, the inventive additive or auxiliary is a phthalimide-enhancing adjuvant which is a surfactant, wetting agent, emulsifier modifier or the like, selected from the group of the following commercial products:
1) Synergen® W03/Synergen® W09: alkyl sulfosuccinate, Na salt in hydrocarbons/white oil.
2) Pluronic® PE 10500 a block copolymer in which the central polypropylene glycol group is flanked by two polyethylene glycol groups, wherein the molar mass of the polypropylene block (hydrophobe) is 3250 and the polyethylene glycol is 50% of the molecule.
3) Synperonic® PE/F 127, poloxamer 407, a triblock copolymer consisting of a central hydrophobic block of polypropylene glycol flanked by two hydrophilic blocks of polyethylene glycol, Pluronic® F-127 mol. Wt.˜12,500.
4) ECOSURF™ EH-3/ECOSURF™ EH-6 a 2-Ethyl hexanol EO-PO nonionic surfactant.
5) Atlox™ 4894 Ethoxylated C₁₂-C₁₅ fatty alcohol (15-30%)+EO-PO Block copolymer n-butyl (40-60%)+Water (10-20%)/Ethoxylated fatty alcohols.
6) Atplus® 242 Ethoxylated Alcohols, C₁₆₋₁₈, (CAS 68439-49-6), in e.g., Propylene glycol [Atplus® 242-LQ-(AP)/Atplus® 242-SO-(CQ].
7) TERGITOL® XD Alkyl EO/PO copolymer (CAS 9038-95-3), Poly(ethylene glycol-ran-propylene glycol) monobutyl ether/Butan-1-ol; ethane-1,2-diol; propane-1,2-diol.
8) Lutensol® XP 80 (CAS 160875-66-1), Ethoxylated 2-propylheptanol/Poly(ethylene oxide) mono-2-propylheptyl ether/Ethoxylated 2-Propylheptanol.

In some embodiments, the phthalimide-enhancing adjuvant is selected from the following group of compounds:
a. particular compounds that include polyalkylene glycol ether moieties in their structure exemplified by, polyalkylene glycol ethers, and alkyl polyalkylene glycol ethers; and
b. particular sulphonic acid-based surfactants, more specifically, sulfosuccinic acid-based surface active agents; including, mono- and diesters of sulfosuccinate metal salts with branched or linear alcohols; sodium dioctyl sulfosuccinate; alkyl Succinate sulphate; and
c. any and all combinations thereof.

In some embodiments, the combination of phthalimide fungicide and phthalimide-enhancing adjuvant are formulated as a ready-mix composition or as a concentrate for dilution before application.

In some embodiments, the combination of phthalimide fungicide and adjuvant is in the form of a composition containing the combination as an enhanced or improved composition.

In some embodiments, the composition comprises at least one agricultural acceptable carrier, typically including water.

In some embodiments, the composition containing the combination is in the form of a suspension, in some of these embodiments the combination is in the form of a liquid, typically, aqueous (water-based) suspension.

In some embodiments, the aqueous suspension is a water suspension which is a tank mix.

In some embodiments, the water suspension is a composition exemplified by a suspension concentrate composition. In some embodiments the suspension concentrate is formulated to be used or applied, as-is.

In some embodiments the suspension concentrate is formulated to be a “ready-mix” which is intended to be diluted prior to application.

In some embodiments, the combination is in the form of a tank mix, or a kit of components adapted, designed, formulated, or provided with instructions or labeling, for being combined and or diluted as a tank mix before application.

It is surprisingly found that the present combinations and compositions comprising phthalimide fungicide in combination with one or more phthalimide-enhancing adjuvants were found to display enhanced control of various fungal pathogens which have a degree of susceptibility to phthalimide fungicides as detailed below. Of particular note, the combinations herein disclosed enable even further enhanced phthalimide control of fungal leaf spot and/blotch diseases caused by zymoseptoria infections in host plants, for example in cereals, such as wheat Septoria tritici blotch, caused by the ascomycete fungus Mycosphaerella graminicola.

Further, these combinations and the compositions containing them, are also found to improve the quality of the plant when applied, by decreasing stress associated with infection by (fungal) pathogen and improving nutrition levels, thereby increasing the yield of the plant that was infected with a fungicidal infection, especially with zymoseptoria tritici infection, and most especially Septoria blotch notably in wheat.

In some embodiments, the combination is applied jointly or in succession to a locus that would benefit from application of a phthalimide fungicide, exemplified by the soil in which plants are either growing or intended to be planted. In some embodiments the application of the components of the combination are applied concomitantly in a manner such that the improvements on fungicidal activity are realized even when the application of each component is not simultaneous. Such adjustments are well within the scope of those ordinarily skilled in these arts.

The present invention also provides a process for preparing a liquid suspension composition of phthalimide fungicide and phthalimide-enhancing adjuvant, the process comprises (1) combining at least one phthalimide fungicide, (2) phthalimide-enhancing adjuvant of the invention and (3) a suspending medium, typically water.

In some embodiments, phthalimide fungicide is folpet. In some embodiments, the phthalimide fungicide is captan. In some embodiments, phthalimide fungicide is captafol. In some embodiments, the phthalimide fungicide is ditalimfos. In some embodiments, the phthalimide fungicide is thiochlorfenphim.

In some embodiments, the present invention provides a suspension composition comprising, based on total weight of the composition, (1) 10-70%±10% w/w phthalimide fungicide, in solid, essentially, particulate form; (2) 0.5-15%±10% w/w of the particular polyalkylene glycol ether-based, or alkyl polyalkylene glycol ether-based surfactant detailed herein; and (3) water.

In some embodiments, the present invention provides a suspension composition comprising (1) 500 g/l±10% folpet, (2) 20-50 g/l±10% of particular compounds including a polyalkylene glycol ether or an alkyl polyalkylene glycol ether as detailed herein; and (3) water.

In some suspension embodiments, compositions comprising the combination of the invention comprise the following components: (a) 10-80%±10% phthalimide fungicide, (b) phthalimide-enhancing adjuvant selected from, (b1) 0.5%-15%±10%, sometimes 0.6%-1.2% 10%, often 0.7% to 1.0% 10%, typically 0.8%±10% of at least one of the particular sulfosuccinic acid-based surface active agents detailed herein; and (b2) 0.5%-15%±10%, sometimes 0.6%-6%±10%, often 0.7% to 1%±10%, typically 0.8%±10%, of at least one surfactant selected from the group of the particular compounds including polyalkylene glycol ether moieties exemplified by, polyalkylene glycol ethers, and alkyl polyalkylene glycol ethers and copolymers of poly ethylene oxide and polypropylene oxide and alkyl ethers thereof such as the particular alcohol alkoxylates, herein disclosed, (c) 0.01%-5.0±10%, often 0.03%-0.75%±10% and typically 0.1-0.4% 10% of at least one, organic, acid, (d) 0.01%-1% 10%, often 0.05%-0.7% 10% and typically 0.1-0.5% 10% of at least one rheological modifier, (e) greater than 0% to 8%±10% of a base or buffer, often, 0.1-5%, typically 0.3-0.7%, (f) 0-10%±10% of further customary formulation assistants, often 1-9%, and typically 3-7% (g) water up to 100%.

In some embodiments, the inventive combination, particularly in the form of a suspension composition, comprises in addition to the inventive combination, a polyelectrolyte which in some noted circumstances is present as a polyelectrolyte complex, and sometimes as a complex of at least two different polyelectrolytes typically being a complex of “polycation” and “polyanion” polyelectrolytes.

A method for improving the performance, or enhancing the biological activity, of a composition comprising a phthalimide fungicide by combining one or more phthalimide-enhancing adjuvants with the phthalimide fungicide, wherein the phthalimide fungicide is one or more of captafol, captan, ditalimfos, folpet, thiochlorfenphim, and any combination thereof and the one or more phthalimide-enhancing adjuvant is selected from the group of, surface active compounds that include polyalkylene glycol ether moieties in their structure and/or sulphonic acid-based surfactants and any and all combinations thereof, wherein the composition that is improved or enhanced comprises one or more polyelectrolytes selected from the group of, polycation; polyanion; polyelectrolyte complex comprising polycation and/or polyanion; and complexed polyelectrolyte formed from the interaction between a polycation and a polyanion, in addition to the one or more phthalimide-enhancing adjuvant.

In some embodiments, the inventive combination in the form of an aqueous or water-based, composition comprises in addition to the inventive combination, a buffer, an acidifier (acid), or other ingredient to adjust the pH of the composition.

The suspension compositions comprising the combinations of the invention are typically aqueous or, water-based suspensions. The phthalimide fungicide in these water compositions is essentially, or even completely in solid particulate form, with minimal or negligible amounts of dissolved phthalimide fungicide.

The present invention also provides a package or kit comprising (1) at least one phthalimide fungicide, (2) at least one phthalimide-enhancing adjuvant compounds selected from group of,
a. particular compounds that include polyalkylene glycol ether moieties in their structure, exemplified by, particular polyalkylene glycol ethers, and particular alkyl polyalkylene glycol ether moieties as disclosed; and
b. particular sulfosuccinic acid-based surface active agents; including, mono- and diesters of sulfosuccinate metal salts with branched or linear alcohols; sodium dioctyl sulfosuccinate; alkyl succinate sulphate; and
c. any and all combinations thereof.

In some embodiments, the kit or package comprises at least two packaged components, one comprising a composition comprising the at least one phthalimide fungicide and at least one package comprising at least one of the phthalimide-enhancing adjuvants, with directions and/or labeling to combine contents of the packages to form a combined composition by e.g., spraying.

In some embodiments, the kit of packaged components includes a concentrated form of composition comprising the at least one phthalimide fungicide combined with directions and/or labeling to dilute and combine contents of the packaged components to form a ready-to-apply composition as e.g., a Tank-mix.

The present invention also provides the use of phthalimide-enhancing adjuvant selected from group of particular compounds including polyalkylene glycol ether moieties in their structure, exemplified by, particular alkyl polyalkylene glycol ether moieties; and particular sulfosuccinic acid-based surface active agents notably including, mono- and diesters of sulfosuccinate metal salts with branched or linear alcohols; sodium dioctyl sulfosuccinate; alkyl succinate sulphate; and any and all combinations thereof, for increasing, enhancing and/or improving the efficacy of a phthalimide fungicide, particularly for the use of increasing the fungal efficacy of a phthalimide fungicide composition.

The present invention also provides the use of phthalimide-enhancing adjuvant selected from group of particular compounds including polyalkylene glycol ether moieties in their structure, exemplified by, particular alkyl polyalkylene glycol ether moieties; and particular sulfosuccinic acid-based surface active agents notably, including, mono- and diesters of sulfosuccinate metal salts with branched or linear alcohols; sodium dioctyl sulfosuccinate; alkyl succinate sulphate; and any and all combinations thereof, for increasing, enhancing and/or improving biological effect of phthalimide fungicide. The biological effect is typically though not limited to, fungicidal control.

The level of fungicidal controlling effect of applying a phthalimide-containing composition, especially suspension, is higher when the phthalimide fungicide-containing composition is applied to a location, locus, or plant in need thereof, in the presence of the inventive phthalimide-enhancing adjuvant as herein defined compared to application of the same composition in the absence of the adjuvant.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “tank mix” means at least two of the components of the combination, mixture or composition of the present invention mixed in a tank. Often the inventive Tank-mixing process involves dilution of a concentrated fungicidal phthalimide material or composition, as well as addition of one or more inventive phthalimide-enhancing adjuvant components.

Inclusion in this disclosure of more than one synonym for the same type of characteristic, exemplified by “enhanced”, “improved”, and/or “increased”, in no way implies that each of these terms is different, but rather included to remove any lack of clarity.

As used herein, the term “plant” includes reference to the whole plant, plant organ (e.g., leaves, stems, twigs, roots, trunks, limbs, shoots, fruits etc.), propagation material, or plant cells.

As used herein, the term “plant” includes reference to agricultural crops including field crops (soybean, maize, wheat, rice, etc.), vegetable crops (potatoes, cabbages, etc.) and perennial crops including fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons, and buds.

As used herein, the term “locus” includes not only areas where pests including fungal pathogens, may already exist, but also areas including soil where a pest or pathogen has yet to emerge, as well as to areas under cultivation or intended for future cultivation or planting.

As used herein, the term “Ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”.

All numerical values or measurements are generally understood to be to some degree approximate, and thus should be considered to be preceded by “approximately” or “about” unless the context makes it clear that an exact figure or value was intended. The term “about” as used herein specifically includes±10% from the indicated values in the range. In addition, the endpoints of all ranges directed to the same component or property herein are inclusive of the endpoints, are independently combinable, and include all intermediate points and ranges.

It is understood that where a parameter range is provided, all integers within that range, and tenths thereof, are also provided by the invention, and as with all numbers, accepted principles of numerical rounding should be employed. For example, “10-50%” includes 9.5%, 10%, 10.1%, 10.2%, etc. up to 50.4%.

While every effort has been expended to avoid the error, if a numerical value disclosed herein has been mistakenly recorded as having more than one numeral after the decimal point, it should be considered to have been an inadvertent error and the figure should be understood to be that value rounded up to a maximum of a single numeral after the decimal point, e.g., within this disclosure, a typographical error that records a figure of “147. 4821”, should be understood that inventor's intention was to refer to a correct value of “148”, unless the context makes clear that 147.5 is required.

The term “polyelectrolyte”, as is used herein, refers to a molecule comprising a plurality of functional, charged groups that are linked to a polymer backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged polymer molecules, respectively, under neutral or acidic conditions, i.e., at pH 3-8. Moreover, the term “polycation” refers to a cationic polymer and the term “polyanion” refers to an anionic polymer.

The term “polyelectrolyte complex”, as is used herein, can refer to a structure that is formed by interaction of at least one polycation or at least one polyanion with another compound, with which it is formulated.

In more noted embodiments, the term “polyelectrolyte complex”, as is used herein, refers to a structure that is formed by interaction of at least one polycation with at least one polyanion. Polyelectrolyte complexes are described, for example, in WO 2013/133705 and WO 2013/133706, the contents of each of which are hereby incorporated by reference. An example of polyelectrolyte complex may be a “polyelectrolyte matrix” (“PEM”).

In some embodiments, pre-formed phthalimide fungicide compositions which can be enhanced by combination with the inventive phthalimide-enhancing adjuvants, comprise polyelectrolyte complex, of either of the above varieties.

The term “polyelectrolyte matrix”, as is used herein, refers to a network that is formed by interaction of at least one polycation with at least one polyanion that result in a matrix-like physical structure.

The term “lignin compound”, as is used herein, refers to a chemical compound that is derived from naturally occurring lignin or lignan by a process that includes sulphonation. The resulting sulfonic acids are strong acids and lignin compounds are therefore negatively charged at pH values below 7.

As used herein, the term “chitosan” refers to a linear polysaccharide composed of randomly distributed (3-(1-4)-linked D-glucosamine (deacetylated unit) and N-acetyl-D-glucosamine (acetylated unit). Chitosan is produced by deacetylation of chitin. The term “chitosan” includes chitosan, chitosan derivatives and mixtures of chitosan and chitosan derivatives. Typically, these chitosan compounds are polycationic.

It was surprisingly found that using an amount of adjuvant selected from group of particular compounds including polyalkylene glycol ether moieties in their structure, exemplified by, particular alkyl polyalkylene glycol ether moieties; and particular sulfosuccinic acid-based surface active agents notably including, mono- and diesters of sulfosuccinate metal salts with branched or linear alcohols; sodium dioctyl sulfosuccinate; alkyl succinate sulphate; and any and all combinations thereof, increases, improves, and/or enhances the phthalimide fungicide including the biological effect (efficacy) of the phthalimide fungicide, notably its fungicidal efficacy.

### Combinations

The present invention provides a combination comprising phthalimide fungicide and phthalimide-enhancing adjuvant selected from the group of particular compounds including polyalkylene glycol ether moieties in their structure, exemplified by, particular alkyl polyalkylene glycol ether moieties; and particular sulfosuccinic acid-based surface active agents, notably including, mono- and diesters of sulfosuccinate metal salts with branched or linear alcohols; sodium dioctyl sulfosuccinate; alkyl Succinate sulphate; and any and all combinations thereof.

In addition to the inventive sulfosuccinic acid-based phthalimide-enhancing adjuvants, some, though not all, of the particular inventive phthalimide-enhancing glycol ether adjuvants suited for use in the inventive combinations with phthalimide fungicides are surface active compounds containing polyglycol ether moieties selected from the group of random, or block, copolymers of polyethylene oxide and polypropylene oxide. In some instances, the glycol ether moiety is end-capped by alcohol residues.

Some noted examples of useful commercially available phthalimide-enhancing adjuvant products are Pluronic PE 10500, Synperonic® PE/F 127, poloxamer 407, Pluronic® F-127, TERGITOL® XD, Lutensol® XP 80, ATPLUS 242-LQ-(AP), Atlox® 4894 and ECOSURF™ EH-3.

The commercial products Synergen® W03 and Synergen® W09 are useful examples of the inventive sulfosuccinic acid-based, phthalimide-enhancing adjuvants, a group which includes the mono- and diesters of sulfosuccinate metal salts with branched or linear alcohols; sodium dioctyl sulfosuccinate; alkyl Succinate sulphate.

Some though not all, of the phthalimide-enhancing adjuvants particularly suited to use in the inventive combinations with phthalimide fungicides are certain alcohol alkoxylates. This term covers a wide spectrum of materials having diverse properties depending on their structure. In particular the structures of
(a) the alcohol moiety, and/or
(b) the alkoxylate moiety,
can affect the properties of the alkoxylates, so that various structure-related technical effects can be exploited.

These technical effects include wetting, spreading, penetration, adhesion, film formation, the improvement of compatibilities, drift control and defoaming. Thus, for example, WO 01/77276, U.S. Pat. Nos. 6,057,284, and 5,661,121 describe certain alcohol alkoxylates as foam-reducing surfactants. These surfactants are block alkoxylates whose alcohol moiety is branched. Clearly these compounds have never been previously considered to have any specific phthalimide-enhancing properties other than their utility as e.g., foam-reducing surfactants.

Thus, it is possible that not every molecule within the widest definition of “alcohol ethoxylates” will have the inventive level of pronounced phthalimide-enhancing activity.

In some asepcts, the inventors have provided experimental examples which may be viewed not only as proof of the surprising advantages made possible by provision of the exemplified phthalimide-enhancing adjuvants but additionally should be viewed as methods by which compounds can be assessed for their phthalimide-enhancing properties, by comparing the performance of compositions with and absent the candidate phthalimide-enhancing adjuvant compound.

In part, the present invention provides new uses of additives or auxiliaries (adjuvants), for enhancing the utility, efficacy etc. of various fungicidal compositions which are based on phthalimide fungicidal active ingredients and where the additives or auxiliaries are particularly exemplified, though not exclusively, by noted members of the group of materials including alkoxylated branched or at least non-linear, alcohols particularly alcohols with C₁₀ or greater chain length and/or branched alkoxylates and/or materials typified by alkoxylates which are ethylene oxide-propylene oxide copolymers (see above), which are either random or block copolymers.

To be clear, inventors do not wish in any way to be bound by theory and simply note that to date many of the useful polyalkoxylated compounds (polyglycol ether compounds) for use as phthalimide-enhancing adjuvant in this inventive combination, composition and methods have been polyalkoxylated branched alcohols having a chain length of C₁₀ and above or they are branched in the alkoxylate portion of the compound including those alkoxylates which are random or block copolymers of ethylene oxide and propylene oxide.

In some embodiments, the polyalkoxylated alcohols (polyglycol ether compounds) for use as phthalimide-enhancing adjuvant in this inventive combination, composition and methods are branched either in the alcohol portion or in the alkoxylate portion of the compound including those alkoxylates which are random or block copolymers of ethylene oxide and propylene oxide.

In some embodiments, the polyalkoxylated compounds for use as phthalimide-enhancing adjuvant in this inventive combination, composition and methods are alkoxylates which are random or block copolymers of ethylene oxide and propylene oxide.

In some embodiments, the polyalkoxylated compounds for use as phthalimide-enhancing adjuvant in this inventive combination, composition and methods are alkoxylates which are random or block copolymers of ethylene oxide and propylene oxide capped with a relatively short (e.g., C₁-C₄), alkyl group.

In some embodiments, the phthalimide-enhancing adjuvant is an alkoxylated fatty alcohol with a chain length of C₁₂ or greater.

In some embodiments, the phthalimide-enhancing adjuvants are ethoxylated C₁₂-C₁₅ alcohols.

In some embodiments, the phthalimide-enhancing adjuvant is an alkoxylated fatty alcohol with a chain length of C₁₆ or greater.

In some embodiments, the phthalimide-enhancing adjuvants are ethoxylated C₁₆-C₁₈ alcohols.

In some embodiments, the phthalimide-enhancing adjuvant is a combination of several compounds containing polyglycol ether moieties such as a combination of an alkoxylated fatty alcohol (C₁₂ or greater chain length), and a random, or block, copolymer of polyethylene oxide and polypropylene oxide, which is optionally capped with a relatively short alkyl group.

In some embodiments, the phthalimide-enhancing adjuvant is an alkoxylated fatty alcohol (C₁₂ or greater chain length) together with a copolymer of polyethylene oxide and polypropylene oxide, capped with a butyl group.

In some embodiments, the phthalimide-enhancing adjuvant are surface active agents selected from the group of random, or block, copolymers of polyethylene oxide and polypropylene oxide.

In some embodiments, the phthalimide-enhancing adjuvants are surface active agents selected from the group of random, or block, copolymers of polyethylene oxide and polypropylene oxide end-capped by alcohol residues.

In some embodiments, the phthalimide-enhancing adjuvants are alkoxylated branched alcohols, particularly branched alcohols with C₁₀ or greater chain length.

In some embodiments, the phthalimide-enhancing adjuvants are alcohols alkoxylated with branched alkoxylates such as ethylene oxide-propylene oxide copolymers, which are either random or block copolymers.

In some embodiments, the phthalimide-enhancing adjuvants are ethylene oxide-propylene oxide copolymers, which are either random or block copolymers.

In some embodiments, the phthalimide-enhancing adjuvants is ethoxylated 2-propylheptanol. In some embodiments, the alkoxylated phthalimide-enhancing adjuvants is ethyl hexanol EO-PO.

In at least one aspect of the invention, the specifically noted useful alcohol alkoxylate or sulfosuccinic acid-based compounds of the invention are combined with at least one phthalimide fungicide as enhancing adjuvant and this aspect clearly includes agrotechnical compositions comprising these compounds and phthalimide fungicide.

In at least one aspect of the invention, specific alcohol alkoxylates are combined with at least one phthalimide fungicide as activity enhancing adjuvant and this aspect clearly includes agrotechnical compositions comprising these alkoxylates and phthalimide fungicide.

One aspect of the present invention therefore relates to the use of at least one of a specific group of alkoxylated alcohols as enhancing adjuvants in the phthalimide fungicide based treatment of plants. A noted example of a useful commercially available product is Lutensol® XP 80, found to be a particularly remarked phthalimide enhancing adjuvant.

In noted embodiments, the phthalimide-enhancing adjuvant is a combination of several compounds containing polyglycol ether moieties. An example of such combination adjuvant is a combination of an identified alkoxylated fatty alcohol and an identified random, or block, copolymer of polyethylene oxide and polypropylene oxide, which is optionally capped with a relatively short alkyl group. A noted example of a useful commercially available product is Atlox® 4894 containing alkoxylated C₁₂-C₁₅ fatty alcohol together with a copolymer of polyethylene oxide and polypropylene oxide, capped with a butyl group in water.

The phthalimide-enhancing adjuvants disclosed above to be used in accordance with the invention have adjuvant properties, often synergistic, properties when combined with phthalimide fungicide. Thus, the addition of such adjuvants makes possible inter alia, an accelerated uptake of phthalimide fungicidally active ingredients when compared to comparable compositions absent the phthalimide-enhancing adjuvant, notably, those phthalimides applied in solid particulate form, by a plant to be treated with the active ingredient. The adjuvant action results in particular in at least the following aspects in the treatment of plants with one or more phthalimide fungicidally active ingredients:
in comparison, higher activity of the active ingredient for a given application rate;
in comparison, lower application rate with a given effect;
in comparison, better uptake of the active ingredient by the plant or plant parts,
in particular via the leaf, and thus advantages for the post-emergence treatment,
in particular the spray fungal treatment of plants.

The use of the compounds in methods according to the invention aims in particular at plant crop cultivation, agriculture, and horticulture. It is intended in particular for controlling undesired fungal pathogens.

Some, though not all, of the exemplary adjuvants particularly suited to use in the inventive combinations with phthalimide fungicides are particular compounds carefully selected from the group of surface active sulfosuccinic acid-based compounds including, mono- and diesters of sulfosuccinate metal salts with branched or linear alcohols; sodium dioctyl sulfosuccinate; alkyl succinate sulphate and any and all combinations thereof, typified by, the commercially available products Synergen® W03 and Synergen® W09.

In some embodiments, the weight ratio between the phthalimide fungicide and the phthalimide-enhancing adjuvant is within a range of between 70:1 to 1:1±10%.

In some embodiments, when the phthalimide-enhancing adjuvant is added as part of a tank mix with a composition comprising phthalimide fungicide, the weight ratio between the composition comprising phthalimide fungicide and the adjuvant is within a range of between 10:1 to 1:3.3±10%.

In some embodiments, when the adjuvant is added as part of a tank mix with a diluted composition comprising phthalimide fungicide, the volume ratio between the diluted composition comprising the phthalimide fungicide to the adjuvant is within a range of between 10:1 to 1:3.3±10%.

In some embodiments, the weight ratio between phthalimide-enhancing adjuvant and phthalimide fungicide is within the range 1:40 to 1:4.5±10%, sometimes 1:8 to 1:5.5±10%.

In some embodiments, when the phthalimide fungicide is folpet and the phthalimide-enhancing adjuvant is Lutensol® XP 80, the weight ratio is 10:1 to 4.5:1±10%.

In some embodiments, when the phthalimide fungicide is captan and the phthalimide-enhancing adjuvant is Lutensol® XP 80, the weight ratio is 10:1 to 4.5:1±10%.

In some embodiments, the phthalimide fungicide and the phthalimide-enhancing adjuvant are formulated as ready-mix composition.

In some embodiments, the combination of phthalimide and phthalimide-enhancing adjuvant is a composition in itself.

In some embodiments, the composition comprising phthalimide and phthalimide-enhancing adjuvant also comprises an agricultural acceptable carrier.

In some embodiments, the combination of phthalimide and phthalimide-enhancing adjuvant or composition containing it, is in the form of an aqueous/water suspension.

In some embodiments, the water/aqueous suspension is a tank mix.

In some embodiments, the combination of phthalimide and phthalimide-enhancing adjuvant or composition or composition containing it is in the form of a suspension concentrate (SC).

In some embodiments, the combination or composition of phthalimide and phthalimide-enhancing adjuvant or composition containing it is in the form of a tank mix.

In some embodiments, the combination or composition of phthalimide and phthalimide-enhancing adjuvant or composition containing it, is applied jointly or in succession so long as at least part of the enhancement, improvement is achieved.

In some embodiments, the water/aqueous suspension is a ready-mix composition sometimes referred to as a concentrate composition.

In some embodiments, the present invention provides a suspension comprising, (1) 30-65%±10% w/w more typically 35-45% 10% of phthalimide fungicide based on total weight of the composition (2) 1-8%±10% w/w more typically 2-6%±10%, of an identified phthalimide-enhancing compound with an alkyl polyalkylene glycol ether moiety, based on total weight of the composition and (3) water.

In some embodiments, the present invention provides a suspension comprising
(1) about 500 g/l±10% folpet,
(2) 40 g/l±10% of a compound with an alkyl polyalkylene glycol ether and
(3) water.

In some embodiments, the suspension comprising phthalimide and phthalimide-enhancing adjuvant comprises a polyelectrolyte complex.

The suspension compositions of the invention are typically aqueous suspensions, sometimes herein referred to as water suspension simply for convenience.

### Composition

In several embodiments, the present invention provides a composition containing the inventive combination comprising phthalimide fungicide and phthalimide-enhancing adjuvant selected from the group of,
(1) at least one phthalimide fungicide,
(2) phthalimide-enhancing adjuvant compounds selected from group of,
   a. particular compounds that include polyalkylene glycol ether moieties in their structure, exemplified by, particular alkyl polyalkylene glycol ether moieties; and
   b. particular sulfosuccinic acid-based surface active agents; including, mono- and diesters of sulfosuccinate metal salts with branched or linear alcohols; sodium dioctyl sulfosuccinate; alkyl Succinate sulphate; and
   c. any and all combinations thereof.

In some embodiments, the phthalimide-enhancing adjuvant also has one or more additional functions, for example, as a surfactant or spreading agent in compositions comprising the inventive combination. It is thus clear that additional incidental advantages are realized when compounding compositions comprising the inventive combinations, these may include improved ease of compounding the compositions. Inventors have established however, that the surprising enhancement attained by combining the phthalimide-enhancing adjuvant with phthalimide fungicides cannot simply be attributed to the aforementioned addition functions, as other ingredients known to have those same functions do not necessarily display the surprising phthalimide-enhancing characteristics that have been discovered as part of this invention.

In some embodiments, the composition comprising the inventive combination of phthalimide-enhancing adjuvant and phthalimide fungicides is in the form of a suspension concentrate. These suspension compositions of the invention are typically aqueous or water-based suspensions.

In some embodiments, the combination of phthalimide-enhancing adjuvant with phthalimide fungicide is formulated in the presence of at least one polycation and/or at least one polyanion.

In some embodiments, the formulation of phthalimide-enhancing adjuvant and phthalimide fungicide comprises both polycation and polyanion in the form of a complex.

In some embodiments, the complex of polyanion and polycation is a polyelectrolyte complex as described in as described in WO2013/133705 and WO2013/133706.

In some embodiments, the concentration of the polyelectrolyte complex in a stable composition including a combination of phthalimide-enhancing adjuvant with phthalimide fungicide according to the invention is typically 0.01-10% by weight based on the total weight of the stable composition.

In some embodiments, the concentration of chitosan as polycation (when present), in the polyelectrolyte complex is about 0.5% by weight based on the total weight of the composition of a combination of phthalimide-enhancing adjuvant with phthalimide fungicide.

In some embodiments, the concentration of poly allyl amine (PAA) as polycation (when present), in the polyelectrolyte complex is about 0.5% by weight based on the total weight of the composition of a combination of phthalimide-enhancing adjuvant with phthalimide fungicide.

In some embodiments, the concentration of chitosan (when present), in the polyelectrolyte complex is about 0.9% by weight based on the total weight of the composition.

In some embodiments, the concentration of PAA (when present), in the polyelectrolyte complex is about 1% by weight based on the total weight of the composition.

In some embodiments, the concentration of the polyanion used for the polyelectrolyte complex (when present), is 0.01-10% by weight based on the total weight of the composition. In some embodiments, the concentration of the polyanion used for the polyelectrolyte complex (when present), is 0.01-8% by weight based on the total weight of the composition. In some embodiments, the concentration of the polyanion (when present), used for the polyelectrolyte complex is 0.1-5% % by weight based on the total weight of the composition.

In some embodiments, the compositions comprise lignosulphonate as polyanion in a polyelectrolyte complex and the concentration of lignosulfonate in the polyelectrolyte complex is less than 5% by weight based on the total weight of the composition.

In some of the above embodiments, the concentration of lignosulfonate in the polyelectrolyte complex is less than 2.5% by weight based on the total weight of the composition.

In some of the above embodiments, the concentration of lignosulfonate in the polyelectrolyte complex is less than 2% by weight based on the total weight of the composition.

In some of the above embodiments, the concentration of lignosulfonate in the polyelectrolyte complex is less than 1.5% by weight based on the total weight of the composition.

In some embodiments, the weight ratio between the polyanion and polycation included in the composition for forming the polyelectrolyte complex is between 10:1 to 1:2, whether or not the actual complex formed includes all the amount of each of the polyanion and polycation, where there might be an “overage” of one polyelectrolyte, a portion of which remaining as uncomplexed or “free” polyelectrolyte in the composition, possibly available for further complex formation.

In some embodiments, the weight ratio between the polyanion and polycation used for the polyelectrolyte complex is between 8:1 to 2:1±10%. In some embodiments, the weight ratio between the polyanion and polycation used for the polyelectrolyte complex is between 5:1 to 2:1. In some embodiments, the weight ratio between the polyanion and polycation used for the polyelectrolyte complex is 5:1. In some embodiments, the weight ratio between the polyanion and polycation used for the polyelectrolyte complex is 2:1.

In some embodiments, the weight ratio between the cationic polyelectrolyte and the anionic polyelectrolyte in the composition is in the range of 2:1 to 1:10. In some embodiments, the weight ratio between the cationic polyelectrolyte and the anionic polyelectrolyte in the composition is in the range of 1:1 to 1:7. In some embodiments, the weight ratio between the cationic polyelectrolyte and the anionic polyelectrolyte in the composition is in the range of 1:2 to 1:5.

In some embodiments the weight ratio between the polycation and polyanion is 1:5. In some embodiments the weight ratio between the polycation and polyanion is 1:2.

In some embodiments, the concentration of the polycation in the polyelectrolyte complex is 0.01-10% by weight based on the total weight of the composition. In some embodiments, the concentration of the polycation in the polyelectrolyte complex is 0.1-5% by weight based on the total weight of the composition. In some embodiments, the concentration of the polycation in the polyelectrolyte complex is 0.1-1.5% by weight based on the total weight of the composition. In some embodiments, the concentration of the polycation in the polyelectrolyte complex is about 0.5% by weight based on the total weight of the composition.

In some embodiments, the concentration of the polycation in the polyelectrolyte complex is about 1% by weight based on the total weight of the composition.

In some preferred embodiments, the amount of the phthalimide fungicide in a composition according to the invention is between 10 and 1000 g/L, more preferred between 100 and 800 g/L such as between 300 and 600 g/L. In some embodiments, the amount of the phthalimide fungicide in the composition is between 350 and 550 g/L. In some embodiments, the concentration of the phthalimide fungicide in the composition is about 512 g/L. As previously mentioned all numerical values should be understood to be ±10% unless clearly stated otherwise.

In some noted embodiments, the concentration of the phthalimide fungicide in a composition according to the invention is 10-80% by weight based on the total weight of the composition, more typically 10-50% by weight based on the total weight of the composition, such as 25-40% by weight based on the total weight of the stable composition.

In some embodiments, the concentration of the phthalimide fungicide in the composition is up to 45% by weight based on the total weight of the composition.

In some embodiments, the concentration of the phthalimide fungicide in the composition is 30-40% by weight based on the total weight of the composition.

In some embodiments, the concentration of the phthalimide fungicide in the composition is 43% by weight based on the total weight of the composition. These noted embodiments being typically concentrated compositions designed for eventual dilution prior to agricultural application.

In some embodiments, the weight ratio between the polyelectrolyte complex and the phthalimide fungicide is between 1:7 and 1:15. In some embodiments, the weight ratio between the polyelectrolyte complex and the phthalimide fungicide is 1:15±10%. In some embodiments, the weight ratio between the polyelectrolyte complex and the phthalimide fungicide is 1:7.5±10%.

As previously mentioned all numerical values should be understood to be ±10% unless clearly stated otherwise.

Acids are often used to obtain dissolution of some polycations. For example, chitosan is an aminoglycan consisting of beta-(1-4)-linked D-glucosamine residues. In acidic environment, global protonation of the 2-amino groups creates cationic chitosan.

In some embodiments, an acid is used to solubilize the polycation in the composition. In some embodiments, the acid has a pKa lower than 5.

In some embodiments, the concentration of the acid in the composition is 0-5% by weight based on the total weight of the composition. In some embodiments, the concentration of the acid in the composition is 0.01-5% by weight based on the total weight of the composition. In some embodiments, the concentration of the acid in the composition is 0.1-3% by weight based on the total weight of the composition. In some embodiments, the concentration of the acid in the composition is 0.1-10% by weight based on the total weight of the composition.

In some embodiments, the composition comprises a buffer, acidifier, pH adjuster or a compound having a similar effect.

As mentioned, in some embodiments, the composition is a suspension concentrate.

In some non-limiting exemplary embodiment, the suspension concentrate comprises the following ingredients merely as illustrative example:
43% w/w of folpet,
0.5% w/w of chitosan,
0.50% Acetic acid,
2.3% calcium lignosulfonate,
4.2% w/w of propylene glycol,
3% w/w Buffering agent,
0.4% w/w of silicone,
5% w/w Phthalimide-Enhancing adjuvant,
0.1% w/w of a biocide,
4.2% w/w of rheology modifier as a 2% gel in propylene glycol/water 20:80, and
37.5% w/w of water.

In some non-limiting exemplary embodiment, the suspension concentrate comprises the following ingredients merely as illustrative example:
30.5% w/w captan,
2.6% w/w fluxapyroxad (non-phthalimide fungicide),
0.50% Acetic acid,
0.2 Xanthan Gum,
2% w/w Atlox® 4913-LQ-(MV),
5% w/w Phthalimide-Enhancing Adjuvant,
3% w/w propylene glycol,
0.02% w/w 1,2-Benzisothiazol-3(2H)-one/Sodium hydroxide (Proxel GXL),
1% w/w SAG™ 1572 foam control agent,
3% w/w sodium acetate,
1% w/w Soprophor® FL,
1% w/w Soprophor® TS/54, and
water.

The present invention includes a product, a process, a system, a kit or use, characterized by one or more elements disclosed in the application.

The present invention provides a use of a fungicide combination to improve performance, or enhance biological activity of a phthalimide fungicide by combining one or more phthalimide-enhancing adjuvants, wherein one or more phthalimide-enhancing adjuvant is selected from the group of, particular compounds including polyalkylene glycol ether moieties in their structure, such as, particular polyalkylene glycol ethers, and alkyl polyalkylene glycol ether moieties; and sulfosuccinic acid-based surface active agents, such as mono- and diesters of sulfosuccinate metal salts with branched or linear alcohols; sodium dioctyl sulfosuccinate; alkyl succinate sulphate; and any and all combinations thereof, wherein the compounds including polyalkylene glycol ether moieties in their structure are selected from the group of:
a) alkoxylated branched alcohols having a chain length of C₁₀ and above;
b) branched alkoxylates such as, random or block copolymers of ethylene oxide and propylene oxide;
c) polyalkoxylated alcohols branched either in the alcohol portion or in the alkoxylate portion of the compound;
d) random or block copolymers of ethylene oxide and propylene oxide;
e) random or block copolymers of ethylene oxide and propylene oxide capped with a short alkyl group, such as a C₁-C₄ chain;
f) alkoxylated fatty alcohol with a chain length of C₁₂ or greater;
g) ethoxylated C₁₂-C₁₅ alcohol;
h) alkoxylated fatty alcohol with a chain length of C₁₆ or greater;
i) ethoxylated C₁₆-C₁₈ alcohols;
j) a combination of an alkoxylated fatty alcohol with C₁₂ or greater chain length, and a random, or block, copolymer of polyethylene oxide and polypropylene oxide, optionally capped with a short alkyl group, such as a C₁-C₄ chain;
k) an alkoxylated fatty alcohol with C₁₂ or greater chain length together with a copolymer of polyethylene oxide and polypropylene oxide, capped with a butyl group;
l) random, or block, copolymers of polyethylene oxide and polypropylene oxide;
m) random, or block, copolymers of polyethylene oxide and polypropylene oxide end-capped by alcohol residues;
n) alkoxylated branched alcohols with C₁₀ or greater chain length;
o) alcohols alkoxylated with branched alkoxylates such as ethylene oxide-propylene oxide copolymers, which are either random or block copolymers;
p) ethoxylated C₁₆-C₁₈ alcohols;
q) ethoxylated 2-propylheptanol.

In some embodiments, the one or more phthalimide-enhancing adjuvants is selected from the group of:
a) alkyl sulfosuccinate, salt;
b) block copolymer in which the central polypropylene glycol (PPG) group is flanked by two polyethylene glycol (PEG) groups;
c) end-capped block copolymer in which the central polypropylene glycol (PPG) group is flanked by two polyethylene glycol (PEG) groups;
d) 2-ethyl hexanol EO-PO;
e) ethoxylated C₁₂-C₁₅ fatty alcohol and EO-PO Block copolymer n-butyl;
f) ethoxylated C₁₆-C₁₈ alcohols;
g) poly(ethylene glycol-ran-propylene glycol) monobutyl ether;
h) ethoxylated 2-propylheptanol and
i) any and all combinations thereof.

The present invention provides a fungicide combination for use to improve performance, or enhancebiological activity, comprising a phthalimide fungicide and one or more phthalimide-enhancing adjuvant selected from the group of, particular compounds including polyalkylene glycol ether moieties in their structure, such as, particular polyalkylene glycol ethers, and alkyl polyalkylene glycol ether moieties; and sulfosuccinic acid-based surface active agents, such as mono- and diesters of sulfosuccinate metal salts with branched or linear alcohols; sodium dioctyl sulfosuccinate; alkyl succinate sulphate; and any and all combinations thereof, wherein the compounds including polyalkylene glycol ether moieties in their structure are selected from the group of,
a) alkoxylated branched alcohols having a chain length of C₁₀ and above;
b) branched alkoxylates such as, random or block copolymers of ethylene oxide and propylene oxide;
c) polyalkoxylated alcohols branched either in the alcohol portion or in the alkoxylate portion of the compound;
d) random or block copolymers of ethylene oxide and propylene oxide;
e) random or block copolymers of ethylene oxide and propylene oxide capped with a short alkyl group, such as a C₁-C₄ chain;
f) alkoxylated fatty alcohol with a chain length of C₁₂ or greater;
g) ethoxylated C₁₂-C₁₅ alcohol;
h) alkoxylated fatty alcohol with a chain length of C₁₆ or greater;
i) ethoxylated C₁₆-C₁₈ alcohols;
j) a combination of an alkoxylated fatty alcohol with C₁₂ or greater chain length, and a random, or block, copolymer of polyethylene oxide and polypropylene oxide, optionally capped with a short alkyl group, such as a C₁-C₄ chain;
k) an alkoxylated fatty alcohol with C₁₂ or greater chain length together with a copolymer of polyethylene oxide and polypropylene oxide, capped with a butyl group;
l) random, or block, copolymers of polyethylene oxide and polypropylene oxide;
m) random, or block, copolymers of polyethylene oxide and polypropylene oxide end-capped by alcohol residues;
n) alkoxylated branched alcohols with C₁₀ or greater chain length;
o) alcohols alkoxylated with branched alkoxylates such as ethylene oxide-propylene oxide copolymers, which are either random or block copolymers;
p) ethoxylated C₁₆-C₁₈ alcohols;
q) ethoxylated 2-propylheptanol; and
r) ethyl hexanol EO-PO.

In some embodiments the fungicide combination comprises:
a) alkyl sulfosuccinate, salt;
b) block copolymer in which the central polypropylene glycol (PPG) group is flanked by two polyethylene glycol (PEG) groups;
c) end-capped block copolymer in which the central polypropylene glycol (PPG) group is flanked by two polyethylene glycol (PEG) groups;
d) 2-ethyl hexanol EO-PO;
e) ethoxylated C₁₂-C₁₅ fatty alcohol and EO-PO Block copolymer n-butyl;
f) ethoxylated C₁₆-C₁₈ alcohols;
g) poly(ethylene glycol-ran-propylene glycol) monobutyl ether;
h) ethoxylated 2-propylheptanol and
i) any and all combinations thereof.

The present invention provides a use of a concentrated or diluted aqueous dispersion to improve and/or enhance treatment and/or protection of a plant locus, a plant, or a part of a plant, against a pathogen susceptible to phthalimide fungicidal treatment, comprising contacting a locus, plant, or part of the plant with the concentrated or diluted aqueous dispersion, wherein the concentrated or diluted aqueous dispersion comprises:
(a) solid particles of at least one phthalimide fungicide; and
(b) one or more phthalimide-enhancing adjuvant selected from the group of:
particular surface active compounds that include polyalkylene glycol ether moieties; particular sulfosuccinic acid-based surface active agents; and any and all combinations thereof, wherein said plant locus comprises the emerged pathogen; soil where the pathogen has yet to emerge, areas under cultivation; areas intended for future cultivation and/or planting, and wherein said parts of a plant comprises one or more of, leaves (foliar application), propagating plant material, plant reproductive material including, seeds, cuttings, seedlings, shoots, roots, rootlets, onions, rhizomes, tubers, branches, stems, calli, buds, fruits and parts or parts thereof and the corresponding genetically modified organisms.

The present invention provides a concentrated or diluted aqueous dispersion for use to improve and/or enhance treatment and/or protection of a plant locus, a plant, or a part of a plant, against a pathogen susceptible to phthalimide fungicidal treatment, wherein the concentrated or diluted aqueous dispersion comprises:
(a) solid particles of at least one phthalimide fungicide; and
(b) one or more phthalimide-enhancing adjuvant selected from the group of:
particular surface active compounds that include polyalkylene glycol ether moieties; particular sulfosuccinic acid-based surface active agents; and any and all combinations thereof, wherein said plant locus comprises the emerged pathogen; soil where the pathogen has yet to emerge, areas under cultivation; areas intended for future cultivation and/or planting, and wherein said parts of a plant comprises one or more of, leaves (foliar application), propagating plant material, plant reproductive material including, seeds, cuttings, seedlings, shoots, roots, rootlets, onions, rhizomes, tubers, branches, stems, calli, buds, fruits and parts or parts thereof and the corresponding genetically modified organisms.

When the above exemplified suspension concentrates (or other concentrates referred to), are diluted e.g., with water in a tank-mix, prior to use, it is clear that the concentrations in % w/w of each ingredient will be considerably less, depending on dilution rate however, clearly the ratio between the components is maintained and thus a diluted composition of an inventive suspension concentrate composition are equally within the scope of this invention. The aforementioned is equally the case if a diluted ready-to-spray composition is made directly rather than from a preformed concentrate which is diluted.

Compositions according to the invention can be in the form of a suspension concentrate (SC), a water dispersible granule (WG), a wettable powder (WP), a dispersion concentrate (DC), a dry powder seed treatment (DS), a water slurry-able powder (WS), or a flowable seed treatment (FS). Often, a composition of the invention is in the form of a suspension concentrate, or in the form of water dispersible granules. The most typical composition is a suspension concentrate.

Clearly, diluted forms of the above-mentioned concentrate forms are carriers (e.g. water) which comprise the inventive concentrate and are fully within the scope of the invention.

In some concentrate embodiments, the concentration of the phthalimide fungicide is up to about 50% by weight based on the total weight of the composition. In some concentrated embodiments, the concentration of the phthalimide fungicide is about 40% by weight based on the total weight of the composition.

In some embodiments, the amount of the phthalimide fungicide in the composition is between 100 and 600 g/L, typically about 500 g/L in concentrated form. As previously mentioned all numerical values including those above, should be understood to be ±10% unless clearly stated otherwise.

In some embodiments, the concentration of the phthalimide fungicide in the concentrated composition is between 15% to 45% by weight based on the total weight of the composition. In some embodiments, the concentration of the phthalimide fungicide in the concentrated composition is between 20% to 35% by weight based on the total weight of the composition. In some embodiments, the concentration of the phthalimide fungicide in the concentrated composition is between 25% to 30% by weight based on the total weight of the composition. In some embodiments, the concentration of the phthalimide fungicide in the composition is 28.8% by weight based on the total weight of the composition.

In some embodiments, the amount of the formulation comprising the phthalimide fungicide in the concentrated composition is between 150 and 500 g/L. In some embodiments, the amount of the formulation comprising the phthalimide fungicide in the composition is between 250 g/L to 450 g/L. In some embodiments, the amount of the formulation comprising the phthalimide fungicide in the composition is between 300 g/L to 400 g/L. In some embodiments, the amount of the formulation comprising the phthalimide fungicide in the composition is about 345 g/L.

In some cases, though clearly not all, improved stability of a phthalimide fungicide suspension is one of the enhancements achieved by the inventive phthalimide-enhancing adjuvant. Clearly, a stable agricultural composition is preferred by the end-users or farmers.

Further, the addition of an additive often affects the chemical and physical stability of the composition to which they are added. Agriculturally acceptable additives that may usefully be added often improve the stability of the composition, for example.

In some embodiments, useful agriculturally acceptable additive is selected from agriculturally acceptable carriers, buffers, acidifiers, antifoaming agents, anti-freeze agents, solvents, co-solvents, agents, light agents, UV absorbers, radical scavengers and antioxidants, adhesives, neutralizers, thickeners, binders, sequestrates, biocides, drift retardants, surfactants, dispersants, pigments, wetting agents, safeners, and preservatives. Said additives include, but are not limited to, surfactants, pigments, wetting agents, as well as safeners, or such preservatives as bacteriostats or bactericides. Each providing their own function.

In some embodiments, the agriculturally acceptable additive is an agriculturally acceptable carrier, and thus, the composition comprises at least one agriculturally acceptable carrier.

In some embodiments, the agriculturally acceptable carrier is water.

In some embodiments, the composition comprises 40-80% by weight of water.

In some embodiments, the composition comprises 50-70% by weight of water.

In some embodiments, the composition comprises 50-55% by weight of water.

In some embodiments, the composition comprises about 52% by weight of water.

In some embodiments, the composition comprises about 53% by weight of water.

In some embodiments, the composition comprises about 54% by weight of water.

In some embodiments, the composition comprises about 55% by weight of water.

The above amounts being mostly relevant to concentrated compositions, prior to dilution.

In some embodiments, the composition is an aqueous composition.

In some embodiments, the composition is suspension concentrate.

In some embodiments the phthalimide fungicide composition and/or the combination comprises additional pesticide e.g., non-phthalimide fungicide, without departing from the invention. In some of these embodiments, the composition comprises water-immiscible carrier. In some examples of these embodiments, the composition is suspoemulsion, wherein the additional pesticide is dissolved in the water immiscible carrier while the phthalimide fungicide is suspended in an aqueous carrier.

### A Polyelectrolyte Complex

In some embodiments, the fungicidal phthalimide composition which is to be enhanced and/or improved by addition of the phthalimide-enhancing adjuvant of the present invention comprises a polyelectrolyte complex.

In some embodiments, the polyelectrolyte complex is a complex of a polycation and a polyanion.

Non-bioactive example of a polycation is, or comprises any of cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof. Typically, said non-bioactive polycation is selected from the group of cationic starch, poly(allylamine), chitosan and chitosan derivatives. In several examples, said non-bioactive polycation is poly(allylamine). Often, said non-bioactive polycation is chitosan.

In some embodiments, the useful polycation in a polyelectrolyte complex which is part of a composition which is enhanced or improved by addition of the phthalimide-enhancing adjuvant according to the invention, is a cationic derivative of starch, poly(allylamine), chitosan, epsilon-poly (L-lysine), chitosan derivatives such as thiolated chitosan, 5-methyl-pyrrolidinone-chitosan and chitosan oligosaccharide and/or DEAE-dextran.

In some embodiments, the useful polyanion in a polyelectrolyte complex which is part of a composition, which is enhanced or improved by addition of the phthalimide-enhancing adjuvant according to the invention is a negatively charged derivative of natural origin, for example, xanthan gum, alginate, a lignin compound such as lignosulfonate, methacrylated lignin sulfonate, pectin, carrageenan, humic acid, fulvic acid, angico gum, gum Kondagogu, poly-γ-glutamic acid, maleic starch half-ester, carboxymethyl cellulose, dextran sulphate, hyaluronic acid, poly(acrylic acid), polyphosphoric acid, poly(L-lactide), polyglycolide, sodium (Na) humate, and/or chondroitin sulfate (CS).

In some embodiments, the polycation is selected from the group of, chitosan (CTS); epsilon-poly-L-lysine (ϵ-PLL); poly allyl amine (PAA); and any mixture thereof. In some embodiments, the polycation is chitosan (CTS). In some embodiments, the polycation is poly allyl amine (PAA). In some embodiments, the polycation is epsilon-poly-L-lysine (ϵ-PLL).

In some embodiments, the polycation is chitosan, epsilon-poly (L-lysine), PAA or any combination thereof.

In some embodiments, the polycation is chitosan and/or poly allyl amine (PAA).

In some embodiments, the polycation is chitosan, poly allyl amine (PAA) and combinations thereof.

In some embodiments, the polycation is chitosan.

In some embodiments, the polycation is PAA.

A non-bioactive polyanion referred to above is commonly of natural origin, for example xanthan gum, alginate, pectin, a lignin compound such as lignosulfonate, carrageenan, humic acid, fulvic acid, angico gum, gum Kondagogu, sodium alkyl naphthalene sulfonate, poly-γ-glutamic acid, maleic starch half-ester, carboxymethyl cellulose, chondroitin sulphate, dextran sulphate, or hyaluronic acid, or of synthetic origin, for example poly(acrylic acid), polyphosphoric acid, and poly(L-lactide), or a mixture thereof, to form a polyelectrolyte complex with a non-bioactive polycation. Typically, the said non-bioactive polyanion is selected from the group of xanthan gum, alginate sodium (Na), chondroitin sulfate (CS), lignosulfonate and any combination thereof. Most typically, said non-bioactive polyanion comprises or is, a lignosulfonate salt. In some embodiments, the polyanion is lignosulfonate.

In some embodiments, the polyanion of the polyelectrolyte complex is lignosulfonate and the dispersant of the aqueous composition is also lignosulfonate.

As has been clearly established and understood additives often have several functions in a composition often depending on the specific manner in which they are incorporated, for example, a portion of a dispersant might no longer function as such if that portion has been bound in a complex.

In some embodiments, the concentration of the polyanion in the composition is less than 5% by weight based on the total weight of the composition (e.g., SC). In some embodiments, the concentration of the polyanion in the composition is less than 3% by weight based on the total weight of the composition (e.g., SC). In some embodiments, the concentration of the polyanion in the composition is less than 2.5% by weight based on the total weight of the composition. In some embodiments, the concentration of the polyanion in the composition is less than 2% by weight based on the total weight of the composition. In some embodiments, the concentration of the polyanion in the composition is less than 1.5% by weight based on the total weight of the composition. In some embodiments, the concentration of the polyanion in the composition is less than 1% by weight based on the total weight of the composition. In some embodiments, the concentration of the polyanion in the composition is less than 0.5% by weight based on the total weight of the composition.

Sodium (Na) humate, a water-soluble Na salt of humic acid derived from leonardite (an oxidation product of lignite), may be chosen as a so-called preconditioning polyelectrolyte. Na humate is a commercially available low-cost material that is increasingly used in biological farming as a soil conditioner, and also to stimulate plant growth.

Sodium humate forms complexes/chelates with cationic dye/metal ions due to the presence of these carboxylate and phenolate groups.

Chondroitin sulfate (CS) is one of the natural glycosaminglycans (GAG) composed of the alternating sugars D-glucuronic acid (GlcA) and N-acetyl-D-galactosamine (GalNAc). It is an important component of the extracellular complex (ECM). Due to the negative charge of CS is considered a strong polyelectrolyte.

In some embodiments comprising a polyelectrolyte complex, the complex is characterized by a non-covalent intermolecular interactions, preferably ionic interaction and hydrogen bonds between donor and acceptor groups of said polycation and said polyanion.

The polyelectrolyte complex is prepared by mixing at least one polyanion and at least one polycation.

In some embodiments, the polycation is protonated prior to interaction with the polyanion. In some embodiments, the polyanion is prepared prior to the interaction with the polycation. In some embodiments, the polyelectrolyte complex is prepared as described in WO2013/133705 and WO2013/133706.

However, it should be emphasized yet again, that the phthalimide compositions which are enhanced and/or improved by the inventive method comprising addition of phthalimide-enhancing adjuvants, do not necessarily include any polycation or polyanion or complex, but rather, those compositions that do include these components are exemplified as they already display a remarkable degree of enhancement/improvement and thus these compositions accentuate the surprising further advantages achievable by the inventive method.

### Diluted Composition

In some embodiments, the present invention provides enhanced and or improved composition which comprise any combination of phthalimide fungicide and phthalimide-enhancing adjuvant disclosed herein as a concentrate, preferably an aqueous suspension concentrate adapted for application use when diluted with water. Typically, this dilution is between 2 and 5000 times with an aqueous solvent, more commonly between 100 and 200 times. Further enhancements and improvements are achievable with the combination of additional phthalimide-enhancing adjuvant with the diluted aqueous suspension concentrate. Clearly a diluted composition which was prepared directly rather than by diluting a previously prepared concentrate having the same ingredient content are no different.

### Uses

The present invention also provides the use of,
i. particular phthalimide-enhancing adjuvant compounds that include polyalkylene glycol ether moieties in their structure, exemplified by, particular alkyl polyalkylene glycol ether moieties; and
ii. particular sulfosuccinic acid-based surface active agents; including, mono- and diesters of sulfosuccinate metal salts with branched or linear alcohols; sodium dioctyl sulfosuccinate; alkyl Succinate sulphate; and
iii. any and all combinations thereof, for improving the performance, or enhancing the biological activity and particularly for increasing the efficacy, particularly, fungicidal efficacy, of phthalimide fungicides.

The present invention also provides the use of phthalimide-enhancing adjuvants selected from group of compounds including:
i. particular phthalimide-enhancing adjuvant compounds that include polyalkylene glycol ether moieties in their structure, exemplified by, particular alkyl polyalkylene glycol ether moieties; and
ii. particular sulfosuccinic acid-based surface active agents; including, mono- and diesters of sulfosuccinate metal salts with branched or linear alcohols; sodium dioctyl sulfosuccinate; alkyl Succinate sulphate; and
iii. any and all combinations thereof, for improving the performance, or enhancing the biological activity and particularly for increasing the biological controlling effect of phthalimide fungicide when combined therewith, wherein the level of controlling effect of the combination, notably in the form of a suspension composition, when phthalimide fungicide is applied in the presence of the phthalimide-enhancing adjuvant is higher than when the phthalimide fungicide is applied in the absence of the adjuvant. The biological controlling effect is typically fungicidal.

### Process

The present invention also provides a typical process for preparing a suspension comprising phthalimide and adjuvant, the process comprises combining, by e.g., mixing,
(1) at least one phthalimide fungicide,
(2) at least one phthalimide-enhancing adjuvant selected from particular phthalimide-enhancing adjuvant compounds that include polyalkylene glycol ether moieties in their structure, exemplified by, particular alkyl polyalkylene glycol ether moieties; particular sulfosuccinic acid-based surface active agents; including, mono- and diesters of sulfosuccinate metal salts with branched or linear alcohols; sodium dioctyl sulfosuccinate; alkyl Succinate sulphate; and any and all combinations thereof, as exemplified in this disclosure, and
(3) water.

### Phthalimide Fungicide

In some embodiments, phthalimide fungicide is selected from folpet, captan, captafol, ditalimfos, thiochlorfenphim and any, and all combinations thereof or combined with non-phthalimide pesticidal active compounds.

In some embodiments, the phthalimide fungicide is folpet.

In some embodiments, the phthalimide fungicide is captan.

In some embodiments, the phthalimide fungicide is captafol.

In some embodiments, the phthalimide fungicide is ditalimfos.

In some embodiments, the phthalimide fungicide is thiochlorfenphim.

In some embodiments, the phthalimide fungicide is combined with additional pesticidal compounds.

### Phthalimide-Enhancing Adjuvant

In some embodiments, the adjuvant useful in implementing the invention is selected from the group of, particular phthalimide-enhancing adjuvant compounds that include polyalkylene glycol ether moieties in their structure, exemplified by, particular alkyl polyalkylene glycol ether moieties; particular sulphonic acid-based surfactants, more particularly sulfosuccinic acid-based surface active agents; including, mono- and diesters of sulfosuccinate metal salts with branched or linear alcohols; sodium dioctyl sulfosuccinate; alkyl Succinate sulphate; and any and all combinations thereof.

In some embodiments, the phthalimide-enhancing adjuvant is one or more sulfosuccinic acid-based surface active agents; including, mono- and diesters of sulfosuccinate metal salts with branched or linear alcohols; sodium dioctyl sulfosuccinate; alkyl succinate sulphate and any and all combinations thereof.

In some embodiments the sulfosuccinic acid-based phthalimide-enhancing adjuvant compound is combined with at least one of the particular phthalimide-enhancing adjuvant which is a surface active compound that includes polyalkylene glycol ether moieties in its structure as described herein.

In some embodiments, the alkyl group of the polyalkylene glycol ether adjuvant is 2-propylheptanol, exemplified by the commercial Lutensol® series of compounds which are ethoxylated 2-propylheptanols CAS 160875-66-1.

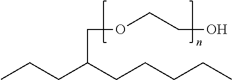

In some embodiments, the Alkyl sulfosuccinate is Synergen® W03 or Synergen® W09 which are alkyl sulfosuccinate, Na salts in hydrocarbons or white oil.

In some embodiments, the phthalimide-enhancing adjuvant is ECOSURF™ EH-3 or ECOSURF™ EH-6, 2-Ethyl hexanol EO-PO nonionic surfactant.

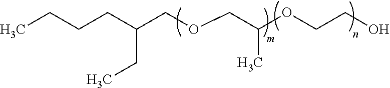

In some embodiments, the adjuvant is TERGITOL® XD, Poly(ethylene glycol-ran-propylene glycol) monobutyl ether.

In some embodiments, the phthalimide-enhancing adjuvant is Pluronic® PE 10500.

In some embodiments, the phthalimide-enhancing adjuvant is Atplus® 242, ethoxylated alcohols, C16-18, CAS 68439-49-6 in Propylene glycol [ATPLUS 242-LQ-(AP)/Atplus 242-SO-(CQ)].

In some embodiments, the phthalimide-enhancing adjuvant is Atlox® 4894 which also includes a butyl end-capped EO/PO copolymer i.e., an ethoxylated C₁₂-C₁₅ fatty alcohol (15-30%)+EO-PO block copolymer n-butyl in water.

In some embodiments the phthalimide-enhancing adjuvant is Synperonic® PE/F 127, poloxamer 407, a triblock copolymer consisting of a central hydrophobic block of polypropylene glycol flanked by two hydrophilic blocks of polyethylene glycol, Pluronic® F-127.

### Additional Pesticide

In some embodiments, the phthalimide fungicide composition comprises a fungicide in addition to phthalimide fungicide, typically selected from the group of azole fungicide, strobilurin fungicides, benzamide fungicide, morpholines, QiI fungicide, SDHI and any combination thereof. The specific surprising degree of enhancements and improvements that result directly from the inventive combinations, compositions containing the combinations and methods for using them, herein disclosed are not those associated or achieved simply by the incorporation of the additional fungicide and compositions containing the additional fungicide(s) are mentioned here to illustrate some embodiments within the scope of protection sought.

In some embodiments, azole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole and prothioconazole, mefentrifluconazole.

In some embodiments, the azole fungicide is tebuconazole.

In some embodiments, the azole fungicide is prothioconazole.

In some embodiments, the azole fungicide is cyproconazole.

In some embodiments, the azole fungicide is difenoconazole.

In some embodiments, strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole and fluoxastrobin.

In some embodiments, the strobilurin fungicide is selected from group consisting of picoxystrobin, trifloxystrobin, azoxystrobin, pyraclostrobin, metominostrobin, metyltetraprole, mandestrobin and a combination thereof.

In some embodiments, the strobilurin fungicide is picoxystrobin.

In some embodiments, the strobilurin fungicide is azoxystrobin.

In some embodiments, the SDHI may include but is not limited to penthiopyrad, boscalid, flutolanil, fluxapyroxad, inpyrfluxam, fluopyram, fluindapyr, benzodiflupyr, bixafen and pydiflumetofen.

In some embodiments, the SDHI fungicide is selected from a group consisting of bixafen; fluxapyroxad, fluindapyr; inpyrfluxam, benzodiflupyr and pydiflumetofen.

In some embodiments, the SDHI fungicide is fluxapyroxad.

In some embodiments, QiI fungicide may include but is not limited to cyazofamid, amisulbrom and fenpicoxamid.

In some embodiments, QiI is fenpicoxamid.

In some embodiments, morpholines may include but are not limited to aldimorph, fenpropimorph, tridemorph, dodemorph, spiroxamine, piperalin, fenpropidin.

In some embodiments, the additional fungicide is azole fungicide.

In some embodiments, the additional fungicide is strobilurin fungicide.

In some embodiments, the additional fungicide is SDHI fungicide.

In some embodiment, the additional fungicide is morpholine.

### Methods of Use

The present invention also provides a method for enhanced control including prevention, of fungicidal disease comprising applying an effective amount of any one of the herein described enhanced or improved compositions, combinations and/or concentrates and/or ready to use dilute compositions, the method comprising the application to a plant, a locus thereof, propagation material thereof, or an area infested with the unwanted pest, or to prevent infestation thereof so as to thereby control the pathogen disease.

Controlling includes preventing curative and persistence treatments.

In some embodiments, the locus of the plant is the vicinity of the plant or where a plant is intended to be cultivated.

In some embodiments, the area or location for application is infested with the pathogen or vulnerable to infestation.

The present invention provides a method for controlling pathogen infection comprising applying an enhanced and/or improved composition comprising:
(1) an amount of phthalimide fungicide,
(2) an amount of adjuvant selected from group of
   i. particular phthalimide-enhancing adjuvant compounds that include polyalkylene glycol ether moieties in their structure, exemplified by, particular alkyl polyalkylene glycol ether moieties; and
   ii. particular sulphonic acid-based surfactants, more specifically sulfosuccinic acid-based surface active agents; including, mono- and diesters of sulfosuccinate metal salts with branched or linear alcohols; sodium dioctyl sulfosuccinate; alkyl succinate sulphate; and
   iii. any and all combinations thereof; and
(3) at least one agriculturally acceptable additive.

The present invention also provides use of the enhanced/improved combination and/or composition, described herein for treating a plant, or a part of a plant, against a pathogen.

The present invention also provides use of the enhanced/improved combination, and/or composition described herein for reducing the rate of application required for treating a plant, or a part of a plant, against a pathogen.

Said method or use of the composition, and/or combination, comprising a phthalimide fungicide, and phthalimide-enhancing adjuvant selected from group of particular phthalimide-enhancing adjuvant compounds that include polyalkylene glycol ether moieties in their structure, exemplified by, particular alkyl polyalkylene glycol ether moieties; and particular sulfosuccinic acid-based surface active agents; including, mono- and diesters of sulfosuccinate metal salts with branched or linear alcohols; sodium dioctyl sulfosuccinate; alkyl Succinate sulphate; and any and all combinations thereof; may result in a reduced rate of application of the phthalimide fungicide required for a beneficial effect.

In some embodiments, reduced rate of application may refer to a rate of application that is more than 20%, preferably more than 50%, reduced, when compared to the recommended rate of application of the same phthalimide fungicide required to achieve the same biological effect in the same crop against the same pathogen, in the absence of the phthalimide-enhancing adjuvant, typically this comparator is the recommended or label rate for each crop/pathogen. The comparative rates of application are readily available either in labelling of commercially available products or in documents issued by environmental agencies.

As an example, for the purposes of defining an exemplary rate of application of folpet in the treatment of Septoria tritici blotch in wheat, the reduced rate of application is an application rate of about 375 g a.i/ha, which is represents a 50% reduction compared with a recommended field application rate of 750 g a.i/ha.

In some embodiments, the inventive enhancement or improvement comprises lower levels of harm while increasing biological activity and may refer to a rate of application that is more than 20%, preferably more than 50%, increased, when compared to the rate of application of the same phthalimide fungicide in absence of the adjuvant, while avoiding the negative consequences normally associated with higher rates of application of the phthalimide fungicide.

The present invention provides a method of improved or enhanced treatment of a plant locus, a plant, or a part of a plant, against a pathogen, susceptible to phthalimide fungicidal treatment at least to some degree, comprising contacting the locus, plant, or part of the plant, with a combination and/or composition comprising the combination as described herein. The parts of the plant generally referred to herein, include the leaves (foliar application), or any propagating plant material or a plant reproductive material, including without limitation, seeds, cuttings, seedlings, shoots, roots, rootlets, onions, rhizomes, tubers, branches, stems, calli, buds, fruits and parts or parts thereof and the corresponding genetically modified organisms. Typically treating a plant will include treating the locus of the plant. Examples of plant locus include not only areas where pests including fungal pathogens, may already exist, but also areas including soil where a pest or pathogen has yet to emerge, as well as to areas under cultivation or intended for future cultivation or planting.

In some embodiments, treatment comprises preventing, reducing and/or eliminating the presence of the pathogen at the plant locus, on the plant, or part of the plant. In some embodiments, treating comprises controlling diseases caused by the pathogen.

In some embodiments, the method of treating the plant locus, the plant, or the part of a plant against a pathogen comprises protecting the plant, or a part of a plant, against the pathogen, comprising contacting the plant, or part of the plant, with any one of any combination, and/or composition, described herein.

In some embodiments, the method of treating the plant locus, the plant, or the part of a plant against a pathogen comprises preventing, reducing and/or eliminating the presence of the pathogen on the plant, or part of the plant, comprising contacting the plant, or part of the plant, with any one of any combination and/or composition described herein.

In some embodiments, the method of treating the plant locus, the plant, or the part of a plant against a pathogen comprises controlling diseases caused by phytopathogenic fungi in plants or on propagation material thereof, which method comprises contacting the plants, or propagation material thereof, with any one of any combination and/or composition described herein.

In some embodiments, the method of treating the plant locus, the plant, or the part of a plant against a pathogen comprises improving pest control comprising applying any one of any combination and/or composition described herein to a plant/or soil.

In some embodiments, the pathogen is phytopathogenic fungi and the method comprises controlling diseases caused by phytopathogenic fungi at the plant locus, in the plant or on propagation material thereof comprising contacting the plant, or propagation material thereof, with any one of any combination and/or composition described herein.

The invention further provides a method of protecting a plant locus, plant, or plant part against a pathogen, comprising contacting said plant or said plant part with a diluted aqueous composition form of the combination according to this invention.

The invention further provides a method of preventing, reducing and/or eliminating the presence of a pathogen at a plant locus, on a plant, or a part of a plant, comprising contacting said plant, or part of said plant, with an aqueous composition according to this invention.

In some embodiments, the method of treating the plant locus, the plant, or the part of a plant against a pathogen comprises preventing, reducing and/or eliminating the presence of the pathogen at the plant locus, on the plant, or part of the plant, comprising contacting the plant locus, the plant, or part of the plant, with any one of any enhanced and/or improved phthalimide combination and/or composition, described herein.

The invention further provides a method of controlling diseases caused by phytopathogenic fungi in plants or on propagation material thereof, which method comprises contacting the plants, or propagation material thereof, with a composition according to the invention, including any aqueous diluted concentrated composition.

In some embodiments, the phthalimide combination and/or composition which has been enhanced or improved, is applied at an amount of 500 to 1000 g/ha±10% more typically 600-800 g/ha±10% of phthalimide fungicide.

An enhanced and/or improved phthalimide composition and/or combination according to the invention is suitable for the control of various pests that are encountered in horticulture, agriculture, and forestry notably fungal pests. The compositions are active against normally sensitive and resistant pest species and during all or individual stages of development. Prior to use, a concentrated composition comprising a phthalimide fungicide combination according to the invention is commonly suspended or dispersed in a carrier, typically, water, or diluted with water, to provide an aqueous composition.

A concentrated form of composition according to the invention is often diluted 2-5000 times, more commonly between about 100-200 times, with an aqueous solvent, preferably water, to contain between 0.01 and 5% (w/v)±10%, of the phthalimide fungicide, prior to contacting a plant, plant part or soil with the enhanced and/or improved composition.

To control agricultural pests, the invention provides a use of a composition comprising a phthalimide fungicide combination according to the invention for the protection of a plant, or a part of a plant, or locus (e.g., soil), thereof, against a pathogen. In order to achieve this effect, said plant or plant part, or soil, is contacted with said composition, including a diluted aqueous forms of the composition.

The inventive composition comprising the inventive combinations is used, for example, to control soybean rust, powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Additional agricultural fungal infections include black sigatoka (black leaf streak) caused by Ascomycetes fungi Mycosphaerella fijiensis (Morelet). Other uses include protection of greenhouse grown flowers and ornamentals, home vegetable gardens and residential turf. In addition, said composition, including a diluted aqueous composition, may be contacted with isolated fruits, nuts, vegetables, and/or flowers.

Particularly noted is the improved performance or enhanced biological activity e.g., efficacy of phthalimide fungicides in controlling fungal diseases including leaf spot diseases caused by zymoseptoria infections in cereals and particularly in wheat plants. The fungal leaf spot diseases include, but are not limited to, tan spot, Septoria/Stagonospora nodorum blotch (SNB) and Septoria tritici blotch (STB), herein exemplified.

For the said uses and said methods, compositions, comprising the inventively enhanced/improved combinations, including diluted aqueous compositions, are preferably sprayed over a plant, or part thereof, or the soil (locus). Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting locations and/or plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g., by means of wax or electrostatically). In addition, the compositions, comprising inventive combinations including diluted aqueous compositions, may be injected into the soil.

For example, a plant of part thereof may be coated with a diluted aqueous composition comprising a phthalimide fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A common part of a plant that is coated with a composition according to the invention, or with a dilution thereof, is seed. A further common part of a plant that is coated with a composition according to the invention, or with a dilution thereof, is leaf A further common part of a plant that is coated with a composition according to the invention, or with a dilution thereof, is a fruit, notably, a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A noteworthy fruit is a citrus fruit, such as orange and/or a tropical fruit such as banana.

The present invention provides a method for improving the performance, or enhancing the biological activity, of a phthalimide fungicide by combining one or more phthalimide-enhancing adjuvants with the phthalimide fungicide, wherein the phthalimide fungicide is one or more of captafol, captan, ditalimfos, folpet, thiochlorfenphim, and any combination thereof and the one or more phthalimide-enhancing adjuvant is selected from the group of, particular phthalimide-enhancing adjuvant compounds that include polyalkylene glycol ether moieties in their structure; and particular sulfosuccinic acid-based surface active agents; including, mono- and diesters of sulfosuccinate metal salts with branched or linear alcohols; sodium dioctyl sulfosuccinate; alkyl Succinate sulphate; and any and all combinations thereof. Each embodiment disclosed herein is contemplated as being applicable to each of the other disclosed embodiments. Thus, all combinations of the various elements described herein are within the scope of the invention. In addition, the elements recited in composition embodiments can be used in the composition, method, use and process embodiments described herein and vice versa.

The invention is illustrated by the following examples without limiting it thereby.

### EXPERIMENTAL SECTION

Different compositions of captan or folpet as a representative phthalimide fungicides with and without phthalimide-enhancing adjuvant were formulated.

The adjuvant was also added as tank mix in examples. As previously mentioned, captan and folpet is being used here in their exemplary capacity and replacement with the other phthalimide fungicides in these preparations is intended to be included so that each preparation should be viewed as having disclosed each preparation multiple times each time with a different phthalimide mutatis mutandis. Additional non-phthalimide fungicides can be included without departing from the invention.

While the inventive phthalimide-enhancing adjuvants are found to inter alia, enhance the biological (fungicidal), efficacy of all aqueous suspension compositions of phthalimides, some of the following examples illustrate the enhancing effect on compositions which are already advantaged optimized by the presence of polyelectrolytes and particularly polyelectrolyte complexes, in the pre-enhanced composition. Two varieties of polyelectrolyte complexes were used in preparations: Polyelectrolyte complex of chitosan, or polyallylamine (PAA) as polycations, each in combination with lignosulfonate as polyanion. The commercial lignosulphonate product Borresperse® CA was used in the illustrative examples as representing of the whole group of similar polyanions, rather than assigning particular significance to this product.

In each preparation illustrated below, it is important to view the functional non-active ingredients (excipients), that are not within the group of inventive phthalimide-enhancing adjuvants, as being representative of the class of non-active ingredients and nothing should be read into the choice of one non-active ingredient type rather than others, e.g., acidifying or buffering agent. The choice of excipient is often based on the physical/chemical stability and composition formulating considerations and it is well within the skill of those ordinarily skilled in the agricultural formulation arts to use alternative excipients without departing from the scope of this invention.

An illustrative non limiting composition and processes might include Enhanced Captan 360 Fluxapyroxad 30 Suspension Concentrate (SC)
30.5% w/w captan,
2.6% w/w fluxapyroxad (non-phthalimide fungicide),
0.5% Acetic acid,
0.2 Xanthan Gum,
2% w/w Atlox® 4913-LQ-(MV),
5% w/w Atplus 242-SO-(CQ) (Phthalimide-Enhancing Adjuvant),
3% w/w propylene glycol,
0.02% w/w 1,2-Benzisothiazol-3(2H)-one/Sodium hydroxide (Proxel GXL),
1% w/w SAG™ 1572 foam control agent (Anti-Foam),
3% w/w sodium acetate,
1% w/w Soprophor® FL,
1% w/w Soprophor® TS/54, and
water.

A preparation might include the following illustrative steps,
Mix water, Acetic acid and Sodium acetate,
Add all dispersants, Propylene Glycol and half the Anti-Foam amount,
Mix well,
Add both Captan and Fluxapyroxad active ingredients,
Perform high shearing,
Mill the suspension to such as to achieve a particle size characterised by D90 Less Than 6 μm,
Add the second half of Anti-Foam,
Add the Phthalimide-Enhancing Adjuvant (Atplus 242),
Mix well,
Add water, thickener (Xanthan Gum) and biocide, and
Adjust viscosity to 1500-2000 cP.

### Enhanced Efficacy Trial

A spray composition was prepared from 200 ml of the above enhanced composition (diluted) and compared to a Tank-mix prepared from 20 ml of a Fluxapyroxad 300 SC concentrate and 150 ml of a Captan 480 SC composition so that both spray mixes comprised 72 g captan active Ingredient (a.i.) and 6 g Fluxapyroxad. The comparison was measured in terms of % Efficacy against Glomerella Leaf Spot (Colletotrichum spp. sexual stage) in apple fruits. The results being the average control achieved in a three location field trial.

TABLE 1

| Treatment | % Efficacy |
|---|---|
| Tank Mix (20 ml of Fluxapyroxad 300 | 82.3 |
| SC + 150 ml of Captan 480 SC) - Control | |
| 6 g fluxapyroxad a.i + 72 g captan a.i | |
| 200 ml of ADM.00601.F.1.G (captan | 89 |
| 360 + Fluxapyroxad 30 SC) - Inventive | |
| 6 g fluxapyroxad a.i + 72 g Captan a.i - | |
| Enhanced Composition | |

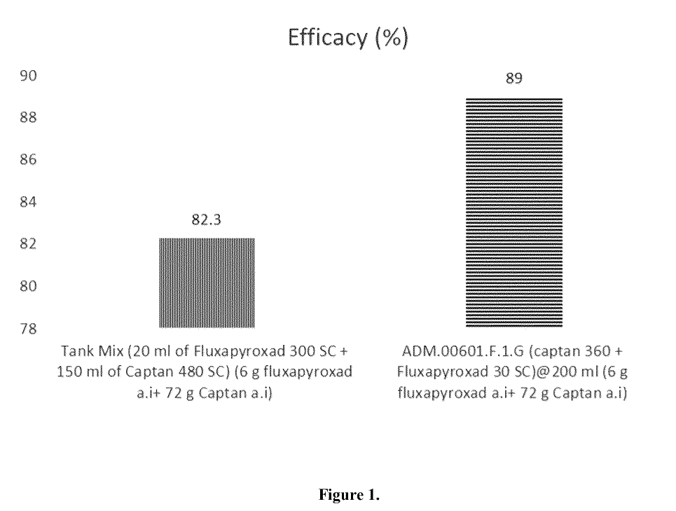

Results indicate that the inventive composition of captan with fluxapyroxad fungicide displays enhanced efficacy when compared to a tank-mix of commercial Captan 480SC and Fluxapyroxad 300SC compositions having the same active ingredient compositions (FIG. 1).

The following general exemplary procedures are disclosed for preparing exemplified phthalimide compositions comprising folpet as phthalimide fungicide active ingredient and polyelectrolyte complex exemplified by e.g., Chitosan-Lignosulphonate. These exemplified procedures relate to improving some of the most effective compositions previously known that are herein further remarkably enhanced by the current invention, but it is recognized that even less optimized phthalimide fungicidal compositions are capable of being enhanced and/or improved by the disclosed combinations with the phthalimide-enhancing adjuvants.

Some illustrative non limiting processes include:
Charge Soft Water into a vessel,
Add Propylene glycol,
Mix until the solution is homogenous,
Add the Polycation (Chitosan), mix until homogenous,
Add an acid (e.g., to aid dissolution),
Mix until homogenous and contents are fully dissolved (visual inspection),
Add Polyanion (lignosulphonate) slowly while mixing,
Homogenize using a high shear homogenizer or similar,
Add a base/buffer,
Mix until homogenous, and the materials are dissolved (visual inspection),
Add the dispersants and antifoam agent exemplified by poly dimethyl siloxanic oil based antifoam (e.g., Silcolapse® 432),
Mix until homogenous,
Add the phthalimide fungicide (e.g., Folpet) gradually, while mixing, to disperse,
Mill and/or homogenize the dispersion,
Add the Phthalimide-Enhancing Adjuvant (if present) and mix, and
Add thickener (e.g., Xanthan gum, Ag RH23) and water and mix.

A more detailed process might include the following:
1. Dissolve a polycation (Chitosan or Polyallylamine) in propylene glycol+water,
2. Where Chitosan is the polycation, acetic acid is added to obtain a solution,
3. Add a polyanion (lignosulfonate) and mix until homogeneous,
4. Add salt(s) exemplified by K₂HPO₄ and KH₂PO₄ and mix for 5 minutes, or until the salt(s) are dissolved,
5. Add phthalimide-enhancing adjuvant exemplified by Poly(ethylene glycol-ran-propylene glycol) monobutyl ether (TERGITOL® XD) and mix e.g., for 15 minutes,
6. Add phthalimide fungicide a.i. e.g., Folpet, portion wise and mix for e.g., 30 minutes,
7. Add antifoaming agent e.g., based on polydimethylsiloxane oil, exemplified by Silcolapse® 426R,
8. Add phthalimide-enhancing adjuvant exemplified by 2-Ethyl hexanol EO-PO nonionic surfactant (Ecosurf® EH-3/Ecosurf® EH-6) and mix for e.g., 15 minutes,
9. Mill/homogenize e.g., with Dynomill® (KDL—500 mL Chamber 80% full of ZrO₂ 0.8-1.0 mm beads) until D₅₀ is below 1.5 μm,
10. Add Xanthan gum and optionally a biocide e.g., BNPD (2-Bromo-2-nitro-1,3-propanediol, Acticide®L10), and
11. Stir until fully incorporated (typically, at least 1 hour).

### Summary of Some Exemplified Compositions

TABLE 2

| Sample | Type | Relevant Ingredients |
|---|---|---|
| Prototype 02 | Comparative | 2% Atlox ® 4913 Ethoxylated |
| | | polymethacrylate graft copolymer |
| Prototype 07 | Inventive | 2% Atlox ®4913 + 5% Lutensol ® XP 80 |
| *Prototype 07+ | Inventive | 2% Atlox ®4913 + 5% + 5% Lutensol ® XP 80 |
| prototype 08 | Inventive | 2% Atlox ®4913 + 3% Synergen ® W03 |
| **Prototype 08+ | Inventive | 2% Atlox ®4913 + 3% + 3% Synergen ® W03 |
| prototype IN03 | Inventive | 1.5% Atlox ® 4913 + 1.5% Atlox ® 4894 |
| prototype IN04 | Inventive | 1.5% Atlox ®4913 + 1.5% Pluronic ® PE |
| | | 10500 |

*Additional_Lutensol ® XP 80 is added to the diluted prototype 07 before application
**Additional_Synergen ® W03 is added to the diluted prototype 08 before application
+Note,
Tergitol ® XD and Ecosurf ® EH-3/Ecosurf ® EH-6 are examples of alternative adjuvants.

Atlox®4913 is Ethoxylated polymethacrylate graft copolymer in water+propylene glycol.

Lutensol® XP 80 is Ethoxylated 2-propylheptanol.

Synergen® W03 is Alkyl sulfosuccinate, Na salt.

Atlox®4894 is Ethoxylated C12-C15 fatty alcohol+butyl end-capped EO-PO Block copolymer.

Pluronic® PE 10500 is an EO-PO-EO Block copolymer.

Tergitol® XD is Poly(ethylene glycol-ran-propylene glycol) monobutyl ether.

Ecosurf® EH-3/Ecosurf® EH-6 is Ethoxylated-Propoxylated 2-Ethyl hexanol.

Synperonic® PE/F 127, poloxamer 407, is a triblock copolymer consisting of a central hydrophobic block of polypropylene glycol flanked by two hydrophilic blocks of polyethylene glycol, aka Pluronic® F-127 mol. Wt. about 12,500.

Atplus®242 is ethoxylated C16-18 alcohols in propylene glycol [Atplus 242-LQ-(AP)/Atplus 242-SO-(CQ)]

CAS 68439-49-6.

### Detailed Comparative Composition

TABLE 3
Folpet 500 SC prototype 02

| Ingredient | % w/w |
|---|---|
| Folpet tech. | 42.07 |
| Soprophor TS/54 | 0.50 |
| Atlox 4913 | 2.00 |
| Citric Acid | 0.85 |
| Sodium hydroxide 15% | 3.07 |
| Silcolapse 432 | 0.34 |
| Chitosan | 0.44 |
| Borresperse CA | 2.20 |
| Propylene glycol | 3.00 |
| 2% AG RH 23 | 8.6 |
| Water | 38.42 |

### Several Inventive Compositions in Detail

An increase in efficacy is shown by adding any one of Pluronic® PE 10500; Lutensol® XP 80; Synergen®W03; Atlox®4894 or combinations of e.g., Lutensol® XP 80 and Synergen® W03, compared to the same composition without the adjuvant.

All disclosed inventive prototypes had enhanced performance and efficacy compared with both a commercially available folpet 500SC product and an equivalent prototype absent the Phthalimide-Enhancing Adjuvant of the invention.

TABLE 4
Folpet 500 SC prototype IN04

| Ingredient | % w/w |
|---|---|
| Folpet a.i. | 42 |
| Atlox ® 4894 | 1.5 |
| Pluronic ® PE 10500 | 1.5 |
| Propylene glycol | 3.4 |
| Borresperse ® CA | 2.2 |
| Chitosan | 0.4 |
| Acetic acid | 0.3 |
| Silicolapse ® 416 | 0.3 |
| K₂HPO₄ | 2.4 |
| 2% AG RH 23 | 10 |
| Water | 36 |

TABLE 5
Folpet 500 SC MCW prototype 07

| Ingredient | % w/w |
|---|---|
| Folpet a.i. | 42 |
| Soprophor ® TS/54 | 0.50 |
| Atlox ® 4913 | 2.00 |
| Citric Acid | 0.85 |
| Sodium hydroxide 15% | 3.3 |
| Silcolapse ® 432 | 0.3 |
| Chitosan | 0.4 |
| Borresperse ® CA | 2.2 |
| Propylene glycol | 3 |
| Lutensol ® XP 80 | 5 |
| 2% AG RH 23 | 5.7 |
| Water | 36 |

TABLE 6
Folpet 500 SC MCW prototype 08

| Ingredient | % w/w |
|---|---|
| Folpet tech. | 42 |
| Soprophor TS/54 | 0.5 |
| Atlox 4913 | 2 |
| Citric Acid | 0.9 |
| Sodium hydroxide 15% | 3.3 |
| Silcolapse 432 | 0.3 |
| Chitosan | 0.4 |
| Borresperse CA | 2.2 |
| Propylene glycol | 3 |
| Synergen ® W03 | 3 |
| 2% AG RH 23 | 8.7 |
| Water | 35.4 |

### Biological Efficacy Trial

Efficacy of Folpet 500 SC applied at a rate of 375 g a.i./Ha against Septoria in wheat Objective—To compare the efficacy of different folpet 500 SC prototypes against Septoria tritici blotch, caused by the ascomycete fungus Mycosphaerella graminicola (asexual stage: Septoria tritici).

### Materials and Methods

Tested formulations—Folpet 500 SC prototypes (see table)
Host plant: Wheat “Mabruk”
Young seedling (2-3 leaves) were grown in pots in the greenhouse (25-35-C with net shade, RH ˜30-50%) for 10 days before the experiment.
Foliar application of formulations with air sprayer.
Following 24 h, plants were inoculated with Septoria sp. suspension (10⁶ CFU/ml).
Inoculated plants were sealed for 3 days with Nylon bag to create best condition for pathogen sporulation (100% humidity).
Plants were grown in the growth chamber (temp 21° C., light/dark 16/8 h, RH 85%) for additional 28 days.
Application volume=200 L/ha
Application 375 g/Ha—50% Recommended field rate of Folpet is 750 g a.i/ha.
Test % pest severity (PESSEV) 4 replicates×2 sets of Trials

TABLE 7

| 1^{st} Test Set - 4 rep | | | 2^{nd} Test Set- 4 rep | | |
|---|---|---|---|---|---|
| per treatment 200 L/ha | | | per treatment 200 L/ha | | |
| | Enhancing | | | Enhancing | |
| Treatment | Adjuvant | g ai/ha | Treatment | Adjuvant | g ai/ha |
| UTC water | | 0 | UTC water | | 0 |
| Prototype 07 | Lutensol XP80 | 375 + 94 | Prototype 07 | Lutensol XP80 | 375 + 94 |
| | Built In | | | Built in | |
| Prototype 08 | Synergen WO3 | 375 + 56 | Prototype 08 | Synergen WO3 | 375 + 56 |
| | (Built in) | | | (Built in) | |
| Commercial | | 375 | Prototype 08+ | Synergen WO3 | 375 + 56 + 5 |
| Folpet 500 SC | | | | Built in + | |
| | | | | Tank Mix | |
| | | | Prototype IN03 | Atlox 4894 | 375 |
| | | | Prototype IN04 | Pluronic PE | 375 |
| | | | | 10500 | |

1. A method for improving the performance, or enhancing the biological activity, of a phthalimide fungicide by combining one or more phthalimide-enhancing adjuvants with the phthalimide fungicide, wherein:
(i) the phthalimide fungicide is selected from the group consisting of captafol, captan, ditalimfos, folpet, thiochlorfenphim, and any combination thereof, and
(ii) the one or more phthalimide-enhancing adjuvants is selected from the group consisting of compounds including polyalkylene glycol ether moieties in their structure; sulfosuccinic acid-based surface active agents; and any and all combinations thereof, wherein the compounds including polyalkylene glycol ether moieties in their structure are selected from the group consisting of:
a) alkoxylated branched alcohols having a chain length of C₁₀ and above;
b) branched alkoxylates such as, random or block copolymers of ethylene oxide and propylene oxide;
c) polyalkoxylated alcohols branched either in the alcohol portion or in the alkoxylate portion of the compound;
d) random or block copolymers of ethylene oxide and propylene oxide;
e) random or block copolymers of ethylene oxide and propylene oxide capped with a short alkyl group, such as a C₁-C₄ chain;
f) alkoxylated fatty alcohol with a chain length of C₁₂ or greater;
g) ethoxylated C₁₂-C₁₅ alcohol;
h) alkoxylated fatty alcohol with a chain length of C₁₆ or greater;
i) ethoxylated C₁₆-C₁₈ alcohols;
j) a combination of an alkoxylated fatty alcohol with C₁₂ or greater chain length, and a random, or block, copolymer of polyethylene oxide and polypropylene oxide, optionally capped with a short alkyl group, such as a C₁-C₄ chain;
k) an alkoxylated fatty alcohol with C₁₂ or greater chain length together with a copolymer of polyethylene oxide and polypropylene oxide, capped with a butyl group;
l) random, or block, copolymers of polyethylene oxide and polypropylene oxide;
m) random, or block, copolymers of polyethylene oxide and polypropylene oxide end-capped by alcohol residues;
n) alkoxylated branched alcohols with C₁₀ or greater chain length;
o) alcohols alkoxylated with branched alkoxylates such as ethylene oxide-propylene oxide copolymers, which are either random or block copolymers;
p) ethoxylated C₁₆-C₁₈ alcohols;
q) ethoxylated 2-propylheptanol;
r) ethyl hexanol EO-PO; and
s) any and all combinations thereof.

2. The method of claim 1, wherein the one or more phthalimide-enhancing adjuvants is selected from the group consisting of:
a) alkyl sulfosuccinate, salt;
b) block copolymer in which the central polypropylene glycol (PPG) group is flanked by two polyethylene glycol (PEG) groups;
c) end-capped block copolymer in which the central polypropylene glycol (PPG) group is flanked by two polyethylene glycol (PEG) groups;
d) 2-ethyl hexanol EO-PO;
e) ethoxylated C₁₂-C₁₅ fatty alcohol and EO-PO Block copolymer n-butyl;
f) ethoxylated C₁₆-C₁₈ alcohols;
g) poly(ethylene glycol-ran-propylene glycol) monobutyl ether;
h) ethoxylated 2-propylheptanol; and
i) any and all combinations thereof.

3. The method of claim 1, wherein the phthalimide fungicide is in a composition comprising the phthalimide fungicide and at least one carrier, wherein the carrier comprises water and the phthalimide fungicide is in the form of phthalimide fungicide particles suspended in the carrier.

4. The method of claim 3, wherein:
a) the one or more phthalimide-enhancing adjuvant is combined with the phthalimide fungicide in an amount of 0.01 to 25% v/v based on the total volume of the composition, and/or
b) the amount of the phthalimide fungicide in the composition is selected from the group consisting of:
i. between 10 and 800 g/L;
ii. between 100 and 500 g/L;
iii. between 300 and 400 g/L;
iv. between 350 and 600 g/L;
v. 512 g/L±10%;
vi. between 10 and 80% w/w based on the total weight of the composition;
vii. between 10 and 50% w/w based on the total weight of the composition;
viii. between 25 and 40% w/w based on the total weight of the composition;
ix. between 30 and 40% w/w based on the total weight of the composition;
x. between greater than 0 and 45% w/w based on the total weight of the composition; and
xi. 43±10% w/w based on the total weight of the composition.

5. (canceled)

6. A fungicide combination with improved performance, or enhanced biological activity, comprising a phthalimide fungicide and one or more phthalimide-enhancing adjuvant selected from the group of compounds including polyalkylene glycol ether moieties in their structure; sulfosuccinic acid-based surface active agents; and any and all combinations thereof, wherein the compounds including polyalkylene glycol ether moieties in their structure are selected from the group consisting of:
a) alkoxylated branched alcohols having a chain length of C₁₀ and above;
b) branched alkoxylates such as, random or block copolymers of ethylene oxide and propylene oxide;
c) polyalkoxylated alcohols branched either in the alcohol portion or in the alkoxylate portion of the compound;
d) random or block copolymers of ethylene oxide and propylene oxide;
e) random or block copolymers of ethylene oxide and propylene oxide capped with a short alkyl group, such as a C₁-C₄ chain;
f) alkoxylated fatty alcohol with a chain length of C₁₂ or greater;
g) ethoxylated C₁₂-C₁₅ alcohol;
h) alkoxylated fatty alcohol with a chain length of C₁₆ or greater;
i) ethoxylated C₁₆-C₁₈ alcohols;
j) a combination of an alkoxylated fatty alcohol with C₁₂ or greater chain length, and a random, or block, copolymer of polyethylene oxide and polypropylene oxide, optionally capped with a short alkyl group, such as a C₁-C₄ chain;
k) an alkoxylated fatty alcohol with C₁₂ or greater chain length together with a copolymer of polyethylene oxide and polypropylene oxide, capped with a butyl group;
l) random, or block, copolymers of polyethylene oxide and polypropylene oxide;
m) random, or block, copolymers of polyethylene oxide and polypropylene oxide end-capped by alcohol residues;
n) alkoxylated branched alcohols with C₁₀ or greater chain length;
o) alcohols alkoxylated with branched alkoxylates such as ethylene oxide-propylene oxide copolymers, which are either random or block copolymers;
p) ethoxylated C₁₆-C₁₈ alcohols;
q) ethoxylated 2-propylheptanol;
r) ethyl hexanol EO-PO; and
s) any and all combinations thereof.

7. The combination of claim 6, wherein the one or more phthalimide-enhancing adjuvants is selected from the group consisting of:
a) alkyl sulfosuccinate, salt;
b) end-capped block copolymer in which the central polypropylene glycol (PPG) group is flanked by two polyethylene glycol (PEG) groups;
c) end-capped block copolymer in which the central polypropylene glycol (PPG) group is flanked by two polyethylene glycol (PEG) groups;
d) 2-ethyl hexanol EO-PO;
e) ethoxylated C₁₂-C₁₅ fatty alcohol and EO-PO block copolymer n-butyl
f) ethoxylated C₁₆-C₁₈ alcohols;
g) poly(ethylene glycol-ran-propylene glycol) monobutyl ether;
h) ethoxylated 2-propylheptanol; and
i) any and all combinations thereof.

8. The combination of claim 6, wherein the phthalimide fungicide is one or more of captafol, captan, ditalimfos, folpet, thiochlorfenphim, and any combination thereof.

9. A fungicide composition comprising the combination of claim 6 and at least one carrier.

10. The composition of claim 9, wherein:
a) the carrier comprises water and the phthalimide fungicide is in the form of particles suspended in the carrier,
b) the phthalimide-enhancing adjuvant is independently chosen from any one or more of, sulfosuccinic acid based surface active agent; alkyl sulfosuccinate or salt thereof, alkoxylated C₁₆-C₁₈ alcohols, ethoxylated propoxylated 2-ethyl hexanol, ethoxylated 2-propylheptanol, Poly(ethylene glycol-ran-propylene glycol) butyl ether, a triblock copolymer consisting of central hydrophobic blocks of polypropylene glycol each flanked by two hydrophilic blocks of polyethylene glycol, ethoxylated C₁₂-C₁₅ fatty alcohol, and a mixture of Poly(ethylene glycol-ran-propylene glycol) butyl ether, and ethoxylated C₁₂-C₁₅ fatty alcohol,
c) the phthalimide-enhancing adjuvant is used in an amount of 0.01 to 25% v/v based on the total volume of the composition, and/or
d) the concentration of the phthalimide fungicide is selected from the group of:
i. between 10 and 800 g/L;
ii. between 100 and 500 g/L;
iii. between 300 and 400 g/L;
iv. between 350 and 600 g/L;
v. 512 g/L±10%;
vi. between 10 and 80% w/w based on the total weight of the composition;
vii. between 10 and 50% w/w based on the total weight of the composition;
viii. between 25 and 40% w/w based on the total weight of the composition;
ix. between 30 and 40% w/w based on the total weight of the composition;
x. between greater than 0 and 45% w/w based on the total weight of the composition; and
xi. 43±10% w/w based on the total weight of the composition.

11-13. (canceled)

14. A method for improved and/or enhanced treatment and/or protection of a plant locus, a plant, or a part of a plant, against a pathogen susceptible to phthalimide fungicidal treatment, said method comprising contacting a locus, plant, or part of the plant, with a concentrated or diluted aqueous dispersion comprising:
(a) solid particles of at least one phthalimide fungicide; and
(b) one or more phthalimide-enhancing adjuvant selected from the group consisting of
surface active compounds that include polyalkylene glycol ether moieties; sulfosuccinic acid-based surface active agents; and any and all combinations thereof,
wherein the plant locus comprises the emerged pathogen; soil where the pathogen has yet to emerge, areas under cultivation; areas intended for future cultivation and/or planting, and
wherein the parts of a plant comprises one or more of, leaves (foliar application), propagating plant material, plant reproductive material including, seeds, cuttings, seedlings, shoots, roots, rootlets, onions, rhizomes, tubers, branches, stems, calli, buds, fruits and parts or parts thereof and the corresponding genetically modified organisms.

15. The method of claim 14, wherein said improvement and/or enhancement comprises:
i) enhanced phthalimide fungicidal control;
ii) improved quality of the plant or parts thereof;
iii) decreased stress of the plant or parts thereof associated with infection by said pathogen;
iv) improved nutrition levels; and/or
v) increased yield;
wherein said pathogen susceptible to phthalimide fungicidal treatment is characterized by causing any, some, or all of, fungal leaf spot, fungal leaf blotch diseases caused by zymoseptoria infections in host plants, for example in cereals, such as wheat or cereals Septoria tritici blotch, tan spot, Septoria/Stagonospora nodorum blotch, and Septoria tritici blotch (STB), soybean rust, powdery mildew, scab, common scab, apple scab, potato black scab, pear scab, powdery scab, peach brown rot, currant and gooseberry leaf spot, peanut leafspot, roses mildew, black sigatoka, and black leaf streak.

16. The method of claim 14, wherein enhanced treatment and/or protection comprises preventing, reducing and/or eliminating the presence of the pathogen at the plant locus, on the plant, and/or part of the plant, wherein contacting comprises application to the plant locus, plant plants, and/or part of the plant, of the combination of claim 6, at a rate of application that delivers the phthalimide fungicide active ingredient (a.i.) at any one selected from the group consisting of:
i) between 0.5 kg/ha±10% and 2.5 kg/ha±10%;
ii) between 1.5 kg/ha±10% and 2 kg/ha±10%;
iii) between 1.6 kg/ha±10% and 3.2 kg/ha±10%;
iv) between 500 g a.i./ha±10% and 750 g a.i./ha±10%;
v) 605 g a.i./ha±10%;
vi) 500 g a.i./ha±10%; and
vii) 750 g a.i./ha±10%.

17. The method of claim 14, wherein contacting comprises application to the plant locus, plant, and/or part of the plant, of the composition of claim 9, wherein the concentration of the phthalimide in the composition is selected from the group consisting of:
i) between 10 g/L±10% and 800 g/L±10%;
ii) between 100 g/L±10% and 500 g/L±10%;
iii) between 300 g/L±10% and 400 g/L±10%;
iv) between 400 g/L±10% and 800 g/L±10%;
v) between 350 g/L±10% and 600 g/L±10%;
vi) between 45 percent±10% and 50 percent±10%;
vii) between 50 percent±10% and 55 percent±10%;
viii) 512 g/L±10%; and
ix) 500 g/L±10%;
wherein the composition is an aqueous dispersion comprising
(a) solid particles of the at least one phthalimide fungicide; and
(b) the one or more phthalimide-enhancing adjuvant.

18. The method of claim 17, wherein the composition is applied at a rate selected from the group consisting of:
i) between 0.1 L/Ha±10% and 5 L/Ha±10% of suspension concentrate;
ii) between 0.5 L/Ha±10% and 2.5 L/Ha±10% of suspension concentrate;
iii) between 0.2 L/Ha±10% and 2 L/Ha±10% of suspension concentrate;
iv) between 0.5 L/Ha±10% and 1.5 L/Ha±10% of suspension concentrate;
wherein the composition is applied as a suspension concentrate that has been diluted between 2 and 5000 times with an aqueous solvent; or a suspension concentrate that has been diluted between 100 and 200 times with an aqueous solvent.

19. The method of claim 14, wherein the application is at a rate of about 200 L/ha of a diluted suspension concentrate to provide contact with 375 a.i. g/Ha of solid particles of at least one phthalimide fungicide; combined with at least one phthalimide-enhancing adjuvant.

20. The method of claim 3, wherein said improved or enhanced composition is a suspension concentrate of phthalimide fungicide particles suspended in the carrier said method further comprising diluting said concentrate by between 2 and 5000 times or between 100 and 200 times with an aqueous solvent and combining an additional amount of at least one, phthalimide-enhancing adjuvant with the diluted suspension concentrate composition, wherein the additional amount of phthalimide-enhancing adjuvant is selected from the group consisting of compounds including polyalkylene glycol ether moieties in their structure, sulfosuccinic acid-based surface active agents, and any and all combinations thereof.

21. (canceled)

22. The method of claim 1, wherein the one or more phthalimide-enhancing adjuvants is selected from the group of:
a) alkyl sulfosuccinate, Na salt (Synergen® W03/Synergen® W09);
b) block copolymer in which the central polypropylene glycol (PPG) group is flanked by two polyethylene glycol (PEG) groups, wherein the molar mass of the PPG block is 3250 and the PEG is 50% of the molecule (Pluronic® PE 10500)
c) triblock copolymer consisting of a central hydrophobic block of polypropylene glycol flanked by two blocks of polyethylene glycol mol. Wt. about 12500 (Synperonic® PE/F 127 poloxamer 407);
d) 2-ethyl hexanol EO-PO nonionic surfactant (ECOSURF™ EH-3/ECOSURF™ EH-6);
e) ethoxylated C₁₂-C₁₅ fatty alcohol+EO-PO Block copolymer n-butyl (Atlox™ 4894)
f) ethoxylated C₁₆-C₁₈ alcohols in propylene glycol (ATPLUS® 242)
g) poly(ethylene glycol-ran-propylene glycol) monobutyl ether (Tergitol® XD)
h) Ethoxylated 2-propylheptanol (Lutensol® XP 80); and
i) any and all combinations thereof.

23. The combination of claim 6, wherein the one or more phthalimide-enhancing adjuvant is selected from the group of:
a) alkyl sulfosuccinate, Na salt (Synergen® W03/Synergen®W09);
b) block copolymer in which the central polypropylene glycol (PPG) group is flanked by two polyethylene glycol (PEG) groups, wherein the molar mass of the PPG block is 3250 and the PEG is 50% of the molecule (Pluronic® PE 10500);
c) triblock copolymer consisting of a central hydrophobic block of polypropylene glycol flanked by two blocks of polyethylene glycol molecular weight. about 12500 (Synperonic® PE/F127 poloxamer 407);
d) 2-ethyl hexanol EO-PO nonionic surfactant (ECOSURF™ EH-3/ECOSURF™ EH-6);
e) ethoxylated C₁₂-C₁₅ fatty alcohol+EO-PO Block copolymer n-butyl (Atlox™ 4894);
f) ethoxylated C₁₆-C₁₈ alcohols in propylene glycol (ATPLUS® 242);
g) poly(ethylene glycol-ran-propylene glycol) monobutyl ether (Tergitol® XD);
h) ethoxylated 2-propylheptanol (Lutensol® XP 80); and
i) any and all combinations thereof.

24. (canceled)

25. A process for preparing the composition of claim 9, wherein the composition is a liquid suspension, wherein the process comprises combining (1) the at least one phthalimide fungicide, (2) the phthalimide-enhancing adjuvant and (3) a suspending medium.

26. (canceled)

27. A method of:
(i) treating the plant locus, the plant, or the part of a plant against a pathogen comprising contacting the plant, or part of the plant, with combination of claim 6, wherein treating the plant locus, the plant, or the part of the plant against the pathogen comprises:
a) protecting the plant, or part of the plant, against the pathogen,
b) preventing, reducing and/or eliminating the presence of the pathogen on the plant, or part of the plant,
c) controlling diseases caused by phytopathogenic fungi in the plant or on propagation material thereof, and/or
d) improving pest control;
(ii) protecting a plant locus, plant, or plant part against a pathogen, comprising contacting theplant or said plant part with a diluted aqueous composition comprising the combination of claim 6,
(iii) preventing, reducing and/or eliminating the presence of a pathogen at a plant locus, on a plant, or a part of a plant, comprising contacting said plant, or part of said plant, with an aqueous composition of the combination of claim 6,
(iv) treating the plant locus, the plant, or the part of a plant against a pathogen comprises preventing, reducing and/or eliminating the presence of the pathogen at the plant locus, on the plant, or part of the plant, comprising contacting the plant locus, the plant, or part of the plant, with the combination of claim 6, or
(v) controlling diseases caused by phytopathogenic fungi in plants or on propagation material thereof, which method comprises contacting the plants, or propagation material thereof, with a composition comprising the combination of claim 6.

28-40. (canceled)
